(19) United States
(12) Patent Application Publication
(10) Pub. No.: US 2019/0143156 A1
(43) Pub. Date: May 16, 2019

(54) CONTINUOUS SAFETY OR BELAY SYSTEM

(71) Applicant: WHITEWATER WEST INDUSTRIES LTD., RICHMOND (CA)

(72) Inventors: MARK WESTON, WAKEFIELD, RI (US); ANTHONY MARINAKIS, NORTH VANCOUVER (CA); RICK BRIGGS, SPRINGFIELD, IL (US); HYUMA FRANKOWSKI, VANCOUVER (CA); GREG MACDOUGALL, NORTH VANCOUVER (CA)

(73) Assignee: WHITEWATER WEST INDUSTRIES LTD., RICHMOND, BC (CA)

(21) Appl. No.: 16/188,145

(22) Filed: Nov. 12, 2018

Related U.S. Application Data
(63) Continuation-in-part of application No. 16/030,427, filed on Jul. 9, 2018.
Application No. 16/030,427 is a continuation of application No. 14/502,950, filed on Sep. 30, 2014, now Pat. No. 10,016,634.
Application No. 14/502,950 is a continuation-in-part of application No. 15/996,359, filed on Jun. 1, 2018.
Application No. 15/996,359 is a continuation of application No. 14/919,254, filed on Oct. 21, 2015, now abandoned.
(60) Provisional application No. 61/884,910, filed on Sep. 30, 2013.
(60) Provisional application No. 62/067,927, filed on Oct. 23, 2014.

(51) Int. Cl. A62B 35/00; A63G 21/20

(52) U.S. Cl. CPC A62B 35/0062; A62B 35/0081; A63G 21/20; A62B 35/0087

(57) ABSTRACT

A safety system is disclosed to provide safety to a user while traversing an amusement attraction. The safety system may include one or more safety mechanisms for attachment to a user and a track system. The one or more safety mechanisms may removably couple together. The one or more safety mechanisms may include additional features such as speed controllers, track engagement systems, among others to assist in the traversal of the safety mechanism through and across the track system.

### CROSS REFERENCE TO RELATED APPLICATIONS

This application is a continuation in part of U.S. patent application Ser. No. 16/030,427 filed, Jul. 9, 2018, which is a continuation of U.S. patent application Ser. No. 14/502,950, now U.S. Pat. No. 10,016,634, filed on Sep. 30, 2014, which claims the benefit of U.S. Provisional Patent App. Ser. No. 61/884,910, filed on Sep. 30, 2013. This application is also a continuation in part of U.S. patent application Ser. No. 15/996,359, filed Jun. 1, 2018, which is a continuation of U.S. patent application Ser. No. 14/919,254, filed Oct. 21, 2015, now abandoned, which claims the benefit of U.S. Provisional Patent App. Ser. No. 62/067,927, filed Oct. 23, 2014. Each of the mentioned applications is incorporated by reference in their entirety into the instant application.

### BACKGROUND

Ropes courses or other challenge or obstacles courses are a popular entertainment activity for both children and adults. Part of the thrill in traversing many of these courses is the high elevation above the ground that a user travels over, for example, by stepping across along pillars, columns, rope bridges, or the like. In order to increase user safety against falling from such heights and potentially being injured, safety systems have been developed that are worn or otherwise fasten with the user traversing the course that prevents the user from dropping to the ground. For example, many safety systems have taken the form of belts or vests worn by the user that are configured to clamp or fasten with a rope or other securing element to a part of the attraction at one end and to the user at the other end. Thus, even if a user loses their balance or footing while traversing the course, the safety system will keep the user from falling beyond a certain distance, for example, by dangling the user in the air and allowing the user an opportunity to regain their footing.

Unfortunately, traditional ropes courses or other challenge or obstacles courses require the user to traverse only along a linear pathway, without deviation, along the course due to the safety system constraints typically being fastened and movable only along such travel path. The level of excitement of the course may be reduced since freedom to move about the course as may be desired by users is prohibited. Many courses that do allow a user the freedom to choose a travel pathway also require the user to stop their movement on the course at a safe area or position and transfer their connection to another pathway. Not only does such a system slow down the number of users that may use the course, but also is inconvenient for users who do not wish to have their play interrupted. Transferring the connection also introduces the risk of the user falling from height by accidentally disconnecting themselves or incorrectly reconnecting to the system.

Thus, a safety or belay system is desired that would allow users the freedom to traverse a ropes, challenge, or other obstacle course along a variety of user-chosen pathways without the inconvenience of unhooking/rehooking to the safety or belay system. Such a system would ideally provide a safe means of preventing injury to users, be reliable in operation and low in manufacturing expense while avoiding the above-mentioned deficiencies of conventional safety systems.

### SUMMARY

The present invention relates to safety systems. More particularly, the present invention relates to a safety system that permits continuous travel by the user along varying pathways without requiring the user to unhook from the safety system before changing direction.

The present invention is related to a continuous safety system for use by participants navigating an aerial challenge course. In one embodiment, a continuous safety system for coupling a user to an amusement attraction may include a first track, a second track that is separate from the first track, a junction box that accepts the first track and the second track, the junction box including a transition surface, and a safety mechanism having a support plate, the safety mechanism configured to couple with the user and travel along the first track, the support plate configured to cooperate with the transition surface of the junction box, wherein the safety mechanism is configured to be moveable between the first track and the second track within the junction box based on the support plate cooperating with the transition surface.

In another embodiment, a safety system for coupling a user to an amusement attraction may include a first track, a second track that is separate from the first track, a junction box that interfaces with the first track and the second track, the junction box including a transition surface, and a safety mechanism having a support plate, the safety mechanism configured to couple with the user and travel along the first track, the support plate configured to cooperate with the transition surface of the junction box, wherein the safety mechanism is configured to be moveable between the first track and the second track within the junction box based on the support plate cooperating with the transition surface.

In still another embodiment, a safety system for coupling a user to an amusement attraction may include an entrance track; a first exit track, a second exit track separate from the first exit track; a pivoting component coupled with the entrance track, the pivoting component configured to transfer between the first exit track or second exit track for providing a track between the entrance track and the first exit track or the entrance track and the second exit track, and a sliding safety mechanism configured to surround at least a portion of the entrance track, the first exit track, the second exit track, or the pivoting component for sliding along the entrance track, the first exit track, the second exit track, or the pivoting component.

In yet another embodiment, a safety system for coupling a user to an amusement attraction may include a first track, a second track separate from the first track, a junction box that interfaces with the first track and the second track, the junction box having a rotating portion containing a support surface, and a safety mechanism configured to couple with the user and travel along the first track or the second track, an exterior surface of the safety mechanism configured to engage with the support surface of the junction box when the safety mechanism is within the rotating portion of the junction box, wherein the safety mechanism is configured to be moveable between the first track and the second track within the junction box by rotating the rotating portion while the safety mechanism is engaged with the support surface.

In yet another embodiment, a method for transferring a trolley on a first track to a second track may include the steps of bringing the first track and the second track within a first predetermined distance of one another, engaging a first latching mechanism coupled with the first track with a second latching mechanism coupled with the second track, engaging the trolley with the second latching mechanism, disengaging the first latching mechanism from the second latching mechanism, and separating the first track from the second track by a second predetermined distance.

### BRIEF DESCRIPTION OF THE DRAWINGS

The features, objects, and advantages of the present invention will become more apparent from the detailed description set forth below when taken in conjunction with the drawings, wherein:

FIG. 1 shows an unharnessed section that may be combined with a harnessed section utilizing a continuous safety or belay system in an amusement attraction according to one embodiment of the present invention;

FIG. 2 shows a plurality of views of an unharnessed section that may be combined with a harnessed section utilizing a continuous safety or belay system according to one embodiment of the present invention;

FIG. 3 shows a plurality of views of an amusement attraction including a harnessed section for traversing along play elements and utilizing a continuous safety or belay system according to one embodiment of the present invention;

FIG. 4 shows a plurality of views of a harnessed section for an amusement attraction that allows leaping between play elements and utilizing a continuous safety or belay system according to one embodiment of the present invention;

FIG. 5 shows a plurality of views of an amusement attraction including a harnessed section for leaping a large distance between play elements and utilizing a continuous safety or belay system according to one embodiment of the present invention;

FIG. 6 shows a plurality of views of an amusement attraction including a harnessed section incorporating a zipline and utilizing a continuous safety or belay system according to one embodiment of the present invention;

FIG. 7 shows an amusement attraction including a harnessed section and utilizing a continuous safety or belay system according to one embodiment of the present invention;

FIG. 8 shows a perspective view of a sliding safety mechanism according to one embodiment of the present invention;

FIG. 9A shows a perspective view of a track of an amusement attraction using a sliding safety mechanism according to one embodiment of the present invention;

FIG. 9B shows a perspective view of the track of the amusement attraction using the sliding safety mechanism of FIG. 9A with an attached lanyard according to one embodiment of the present invention;

FIG. 9C shows a perspective view of a pivoting track of an amusement attraction using a sliding safety mechanism according to one embodiment of the present invention;

FIG. 9D shows a zoomed-in perspective view of a portion of the pivoting track of an amusement attraction using a sliding safety mechanism of FIG. 9C according to one embodiment of the present invention;

FIG. 10A shows a perspective view of a rolling safety mechanism according to one embodiment of the present invention;

FIG. 10B shows a plurality of views of the rolling safety mechanism of FIG. 10A according to one embodiment of the present invention;

FIG. 11A shows a perspective view of a junction box for use with a sliding safety or belay mechanism according to one embodiment of the present invention;

FIG. 11B shows a side view of the junction box of FIG. 11A according to one embodiment of the present invention;

FIG. 11C shows a side view of the junction box of FIG. 11A with an included safety or belay mechanism within according to one embodiment of the present invention;

FIG. 11D shows a plurality of views of the junction box of FIG. 11A according to one embodiment of the present invention;

FIG. 11E shows a perspective view of the operation of a safety or belay system with the junction box of FIG. 11A according to one embodiment of the present invention.

FIG. 12 shows a perspective view of a rolling safety mechanism on a track according to one embodiment of the present invention;

FIG. 13A shows a perspective view of a rolling safety mechanism and an associated junction box according to one embodiment of the present invention;

FIG. 13B shows a zoomed-in perspective view of the rolling safety mechanism and the associated junction box of FIG. 13A according to one embodiment of the present invention;

FIG. 13C shows a plurality of top views of the rolling safety mechanism and the associated junction box of FIG. 13A according to one embodiment of the present invention;

FIG. 13D shows a zoomed-in cutaway top view of the rolling safety mechanism and the associated junction box of FIG. 13A according to one embodiment of the present invention;

FIG. 14 shows a perspective view of a body for a rolling safety mechanism with corresponding URES displacement data according to one embodiment of the present invention;

FIG. 15 shows a perspective view of a body for a rolling safety mechanism with corresponding static nodal stress data according to one embodiment of the present invention;

FIG. 16 shows a plurality of views of a passing lane configuration for use with a safety or belay mechanism according to one embodiment of the present invention;

FIG. 17 shows a perspective view of a rotating junction box for use with a safety or belay mechanism according to one embodiment of the present invention;

FIG. 18A shows a bottom perspective view of a slider clamp track with a rotatable component for use with a safety or belay mechanism according to one embodiment of the present invention;

FIG. 18B shows a side perspective view of the slider clamp track with a rotatable component of FIG. 18A for use with a safety or belay mechanism according to one embodiment of the present invention;

FIG. 18C shows an exploded side perspective view of the slider clamp track with a rotatable component of FIG. 18A for use with a safety or belay mechanism according to one embodiment of the present invention;

FIG. 19 shows a schematic of handshake operation for an amusement attraction utilizing a safety or belay mechanism according to one embodiment of the present invention;

FIG. 19A shows a zoomed-in portion of the schematic of handshake operation of FIG. 19 according to one embodiment of the present invention;

FIG. 19B shows a zoomed-in portion of the schematic of handshake operation of FIG. 19 according to one embodiment of the present invention;

FIG. 19C shows a zoomed-in portion of the schematic of handshake operation of FIG. 19 according to one embodiment of the present invention;

FIG. 19D shows a zoomed-in portion of the schematic of handshake operation of FIG. 19 according to one embodiment of the present invention;

FIG. 19E shows a zoomed-in portion of the schematic of handshake operation of FIG. 19 according to one embodiment of the present invention;

FIG. 20 shows dimension information for an I-beam structural support that may be used in a harnessed course or unharnessed course of an amusement attraction according to one embodiment of the present invention;

FIG. 21 shows dimension information for an I-beam structural support that may be used in a harnessed course or unharnessed course of an amusement attraction according to one embodiment of the present invention;

FIG. 22 shows a plurality of harnessed activities that may be performed between sections of track in a harnessed course of an amusement attraction according to one embodiment of the present invention;

FIG. 23 shows handshaking operation between a trolley and a track according to one embodiment of the present invention;

FIG. 24A shows a front view of a handshaking operation between a trolley and a track according to one embodiment of the present invention;

FIG. 24B shows a rear view of the handshaking operation between a trolley and a track of FIG. 24A according to one embodiment of the present invention;

FIG. 24C shows a top view of the handshaking operation between a trolley and a track of FIG. 24A according to one embodiment of the present invention;

FIG. 25 shows handshaking operation between a trolley and a track according to one embodiment of the present invention.

FIGS. 26A-26B shows a plurality of views of an amusement attraction including a harnessed section utilizing a continuous safety or belay system according to embodiments of the present invention.

FIG. 26C shows an exemplary safety mechanism for use with the amusement attraction of FIGS. 26A-26B according to embodiments of the present invention.

FIG. 27A shows a perspective view of the left, front, and top aspects of a rolling safety mechanism according to an embodiment of the invention.

FIG. 27B shows a perspective view of the right, front, and top aspects of a rolling safety mechanism of FIG. 27A.

FIG. 27C shows a front view of the rolling safety mechanism of FIG. 27A mounted on a track.

FIG. 27D shows a perspective view of the rolling safety mechanism of FIG. 27A.

FIG. 28 shows a perspective view of a safety mechanism according to an embodiment of the invention.

FIG. 29 shows a perspective partial view of a first safety mechanism coupled with a second safety second safety mechanism according to embodiments of the invention.

FIG. 30 shows a front perspective view of the combined first and second safety mechanism on respective individual tracks while being coupled directly together.

FIGS. 31A-31D show different views of an exemplary docking station according to embodiments of the invention for use with the safety mechanisms described herein.

FIG. 32 illustrates an exemplary portion of an amusement attraction including a landing portion of a docking station.

FIG. 33 illustrates an exemplary embodiment of a conveyor system according to embodiments described herein.

FIG. 34 illustrates a configurable track according to embodiments described herein.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

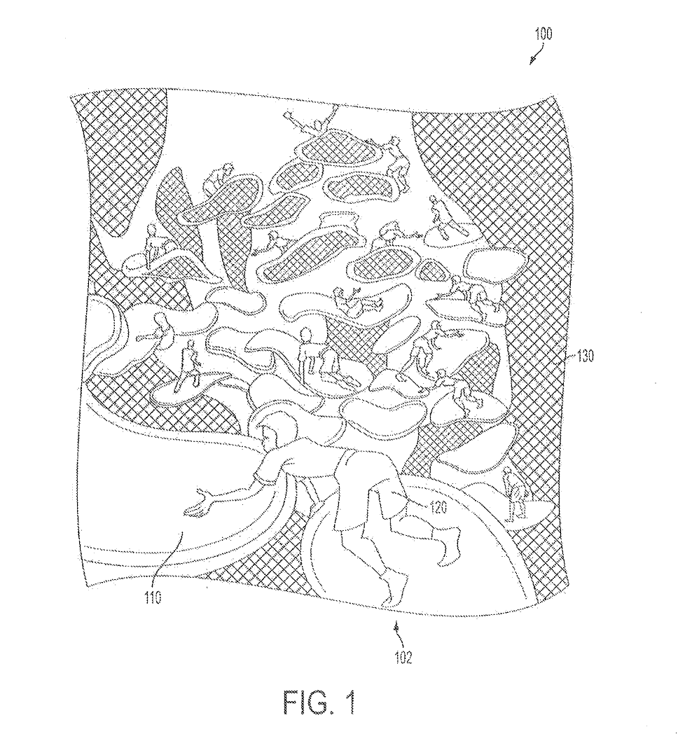

Turning first to FIG. 1, an amusement attraction 100 is shown, including an unharnessed section 102 (e.g., a series of platforms that users may jump between with a safety netting disposed underneath). As discussed in greater detail herein, the amusement attraction 100 may also include harnessed sections that utilize a continuous safety belay system. In the unharnessed section 102, users are free to traverse the area without the need of a safety system that couples the user to the amusement attraction, for example, to aid in preventing injury. For example, one or more platforms 110 may be spaced apart from one another so that a user 120 may traverse the platforms 110. A safety netting or mesh 130 may be disposed beneath one or more of the platforms 110 such that the user 120 can safely traverse them without risking injury if the user 120 were to fall.

In a harnessed section, users are coupled (e.g., by way of a rope or cloth tether) to the amusement attraction 100 for safety purposes. As discussed in greater detail herein, the continuous safety or belay system may allow users to traverse among multiple pathways, at the users' discretion, without requiring the users to unhook and/or rehook to the safety or belay system. Although FIG. 1 illustrates one potential setup or design for the amusement attraction 100 with an unharnessed section 102 with possible incorporation with a harnessed section, in an alternative embodiment, any of a variety of possible setups or designs may be used. For example, in one embodiment, no unharnessed section 102 may be included as part of the amusement attraction 100.

In one embodiment, different tracks or travel paths may each correspond to a different type of activity or challenge. For example, a first track may include or lead through a rope bridge, a second track may include or lead through a zipline, a third track may include or lead through a vertical drop activity, a fourth track may include or lead through a vertical climbing activity, etc. Thus, a user of the amusement attraction may choose to follow the particular track or travel path that leads to or through the activity or challenge that they desire. Moreover, if one activity is particularly congested by a multitude of users, such user may opt to follow a different track or travel path through a different activity until the congestion clears. Tracks or travel paths may extend throughout the usable space of the amusement attraction (e.g., horizontal or substantially beams or tracks, such as a ropes course, may connect with a vertical ascent, such as a climbing or rock wall, which may connect to a diagonal descent, such as a zip line, which may connect to a diagonal ascent, such as a sloped track, and etc.). In an alternative embodiment, any or all of the above described exemplary combinations or permutations of ride activities or challenges may be included and/or combined with additional ride elements.

The unharnessed section 102 of the amusement attraction 100 may allow users participating within its borders without harnesses to follow, direct, or otherwise interact with those in a harnessed section of the amusement attraction 100. For example, an activity in the unharnessed section 102 may be interwoven in and around activities in the harnessed section so as to create a more exciting or thrilling ride experience for users of both the unharnessed section 102 and the harnessed section. Parents or older users on the harnessed section activities may be able to simultaneously keep an eye on children or younger users in the unharnessed section 102 without being required to idly stand next to the amusement attraction 100.

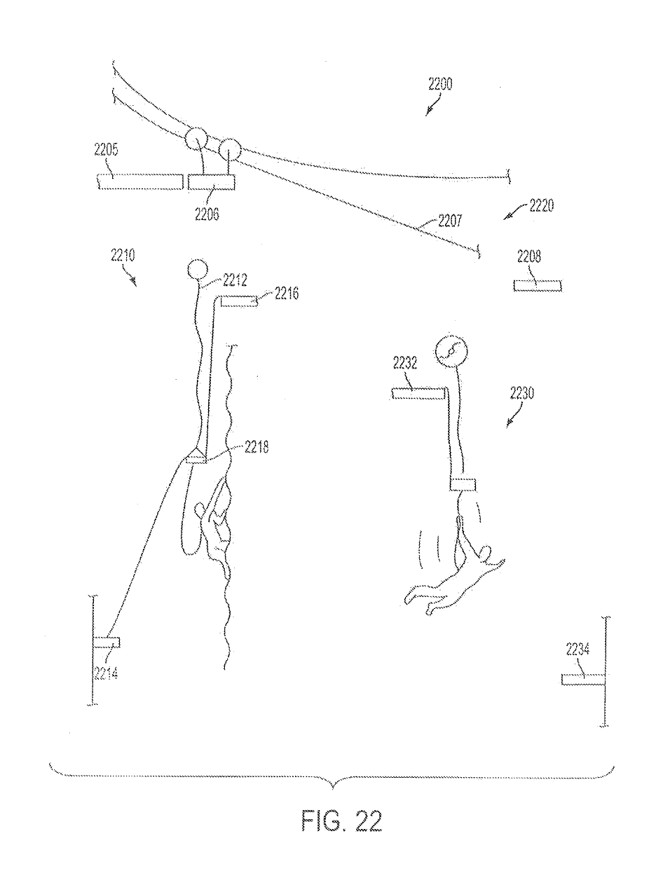

In one embodiment, users of the unharnessed section 102 may be allowed to interact with ride elements (e.g., buttons, switches, knobs, etc.) that act to modify a portion of the harnessed section (moving platforms, gusts of air, etc.). In certain embodiments, users in the unharnessed section 102 may only be permitted to engage in the activities of the unharnessed section 102 independent of the harnessed section users or activities. I-beams may be used to provide strong, structural support for features or activities in either the harnessed section and/or the unharnessed section 102 (see exemplary dimensional information for such I-beams in FIG. 22).

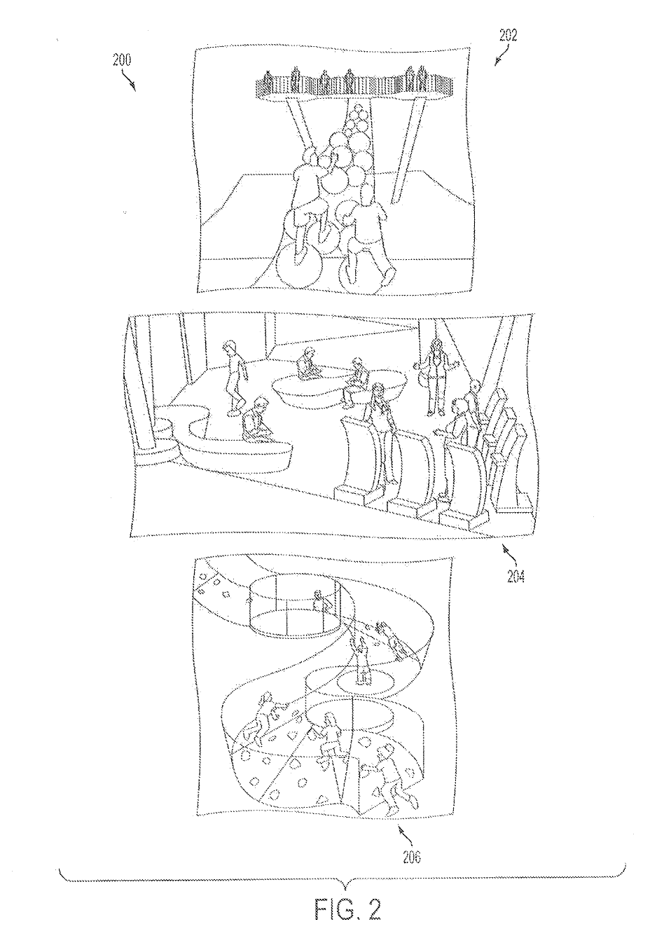

FIG. 2 shows a plurality of views of various unharnessed sections (202, 204, 206) in an amusement attraction 200 (e.g., a series of platforms or bridges that users may traverse across) that may be interwoven with one or more harnessed sections that utilize a continuous safety or belay system, the same as or similar to those discussed above. In the unharnessed sections (202, 204, 206), users are free to traverse the area without the need of a safety system that couples the user to the amusement attraction, for example, to aid in preventing injury. For example, unharnessed section 202 allows users to cross a bridge or sequence of obstacles above a safety netting or mesh. In another example, unharnessed section 204 permits users to participate in activities within an enclosed area having a solid floor and walls. In still another example, unharnessed section 206 permits users to traverse a pathway having walls on either side in order to contain the users for safety purposes.

In a harnessed section, users are coupled to the amusement attraction 200 for safety purposes. As discussed in greater detail herein, the continuous safety or belay system may allow users to traverse among multiple pathways, at the users' discretion, without requiring the users to unhook and/or rehook to the safety or belay system. Although FIG. 2 illustrates one potential setup or design for the amusement attraction 200 that includes the unharnessed sections 202 that may be interwoven or interconnected with a harnessed section, in an alternative embodiment, any of a variety of possible setups or designs may be used.

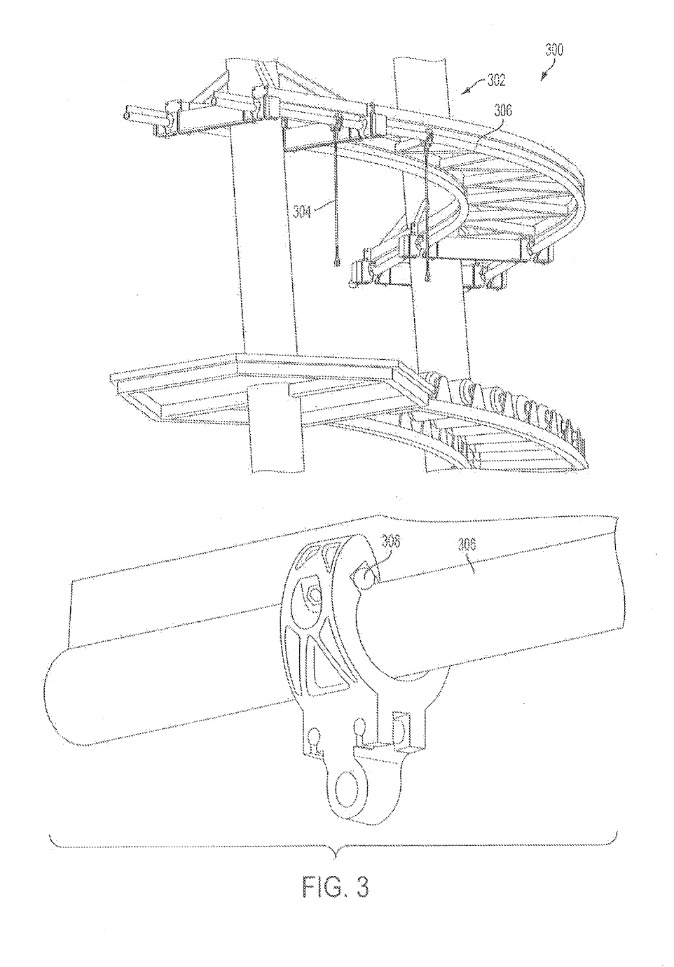

FIG. 3 shows a plurality of views of an amusement attraction 300 including a harnessed section 302 for traversing along play elements (e.g., along rope bridges, rope stairs, etc.) and utilizing a continuous safety or belay system, as discussed in greater detail herein. In the harnessed section 302, users are coupled (e.g., via a rope and/or track coupling element) 304 to a track 306 of the amusement attraction 300, for example, for safety purposes. As discussed in greater detail herein, the continuous safety or belay system may allow users to traverse among multiple pathways or tracks, at the users' discretion, without requiring the users to unhook from the coupling 304 and/or re-hook the coupling 304 to a different track segment of the safety or belay system. The coupling element that couples 304 a user to the track 306 may slide along the track 306 or may be configured to roll along the track (e.g., via rollers, wheels, or bearings 308). Although FIG. 3 illustrates one potential setup or design for the amusement attraction 300 that includes the harnessed section 302, in an alternative embodiment, any of a variety of possible setups or designs may be used.

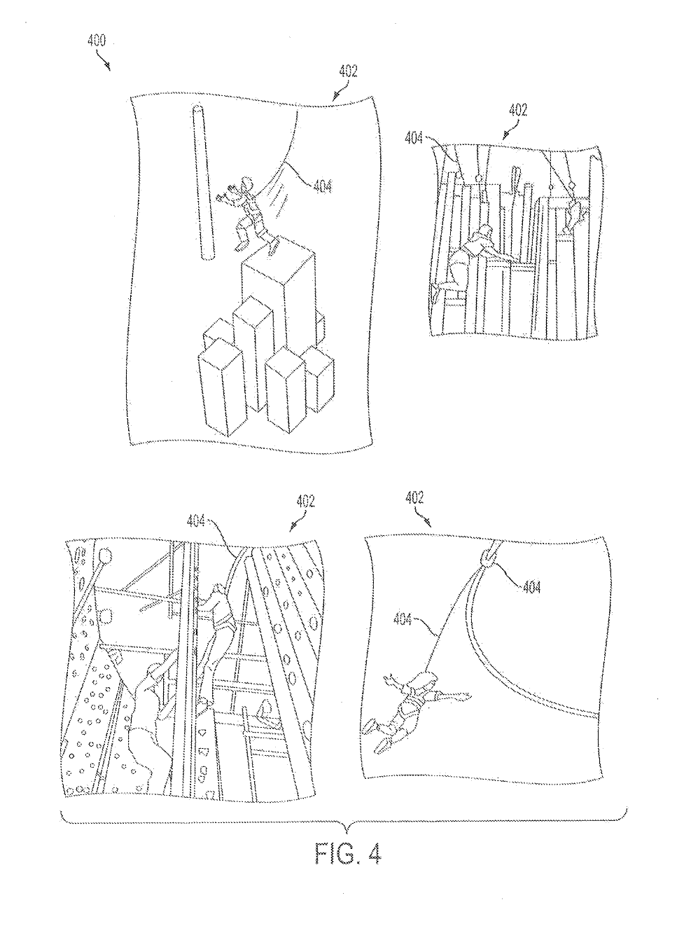

FIG. 4 shows a plurality of views of a harnessed section 402 for an amusement attraction 400 that allows leaping between play elements and utilizing a continuous safety or belay system, as discussed in greater detail herein. For example, a user may be allowed to leap or climb across gaps (e.g., between poles or columns, from one platform to another, etc.) while located at an elevation above a floor or lower surface of the amusement attraction 400. In the harnessed section 402, users are coupled (e.g., via a rope and/or track coupling element) 404 to the amusement attraction 400 for safety purposes. As discussed in greater detail herein, the continuous safety or belay system may allow users to traverse among multiple pathways, at the users' discretion, without requiring the users to unhook and/or rehook to the safety or belay system. Although FIG. 4 illustrates one potential setup or design for the amusement attraction 400 that includes the harnessed section 402, in an alternative embodiment, any of a variety of possible setups or designs may be used.

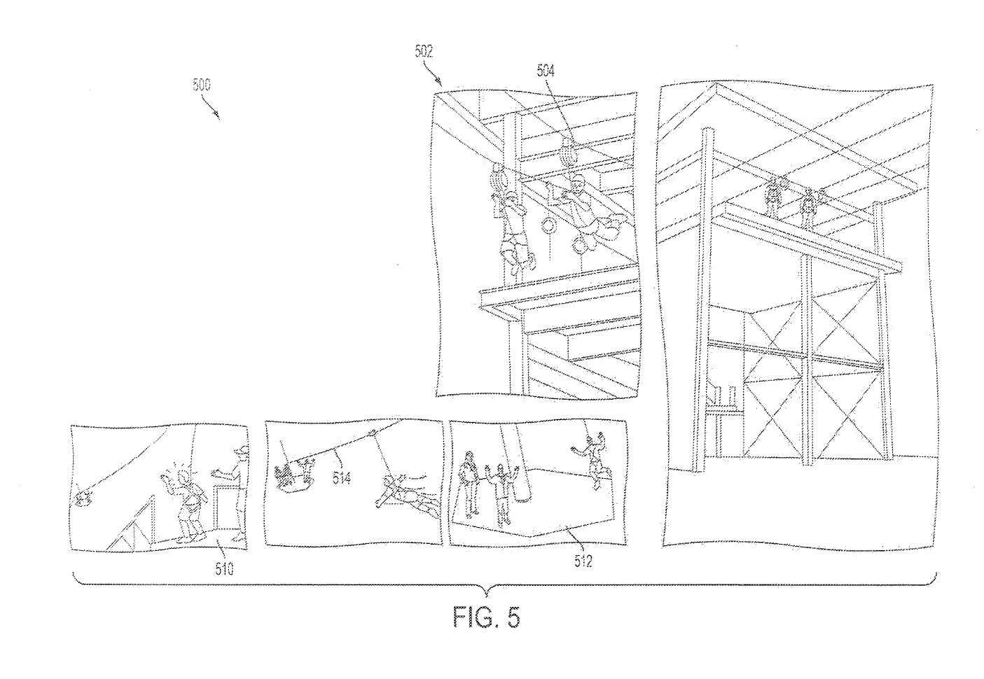

FIG. 5 shows a plurality of views of an amusement attraction 500 including harnessed sections 502 utilizing a continuous safety or belay system, as discussed in greater detail herein, that allows a user to leap or slide a long distance across a wide gap (e.g., from a first platform 510 to a second platform 512 located beyond the jumping capabilities of a user, etc.) while located at an elevation above a floor or lower surface of the amusement attraction 500. The user leaps from the first platform 510 and slides or rolls along a zip line or other component 514 towards the second platform 512. In the harnessed section 502, users are coupled (e.g., via a rope and/or track coupling element) 504 to the amusement attraction 500 for safety purposes. As discussed in greater detail herein, the continuous safety or belay system may allow users to traverse among multiple pathways, at the users' discretion, without requiring the users to unhook and/or rehook to the safety or belay system. Although FIG. 5 illustrates one potential setup or design for the amusement attraction 500 that includes the harnessed section 502, in an alternative embodiment, any of a variety of possible setups or designs may be used.

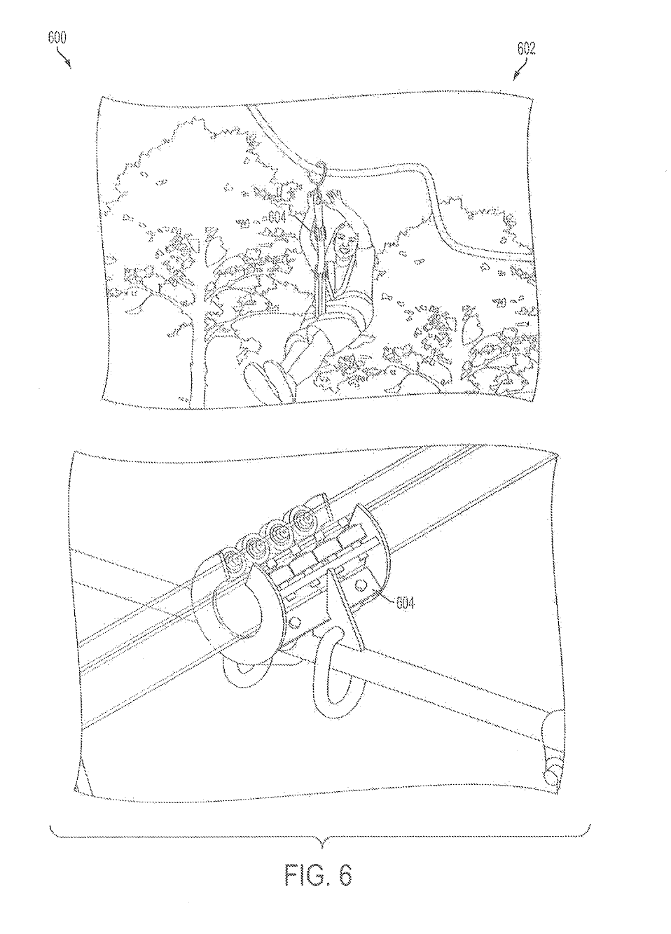

FIG. 6 shows a plurality of views of an amusement attraction 600 including a harnessed section 602 utilizing a continuous safety or belay system, as discussed in greater detail herein, which allows a user to slide along a zipline located at an elevation above a floor or lower surface of the amusement attraction 600. The user travels along the zipline from one portion of the amusement attraction 600 to another portion (e.g., at a fast rate of speed). In the harnessed section 602, users are coupled (e.g., via a rope and/or track coupling element) 604 to the amusement attraction 600 for safety purposes. As discussed in greater detail herein, the continuous safety or belay system may allow users to traverse among multiple pathways, at the users' discretion, without requiring the users to unhook and/or rehook to the safety or belay system. Although FIG. 6 illustrates one potential setup or design for the amusement attraction 600 that includes the harnessed section 602, in an alternative embodiment, any of a variety of possible setups or designs may be used.

FIGS. 26A-26B shows a plurality of views of an amusement attraction 2600 including a harnessed section 2602 utilizing a continuous safety or belay system, as discussed in greater detail herein, which allows a user to traverse paths having a vertical component, and tight turns (e.g., spiral stair climb). The user travels along the spiral vertical path from a lower or higher elevation of the amusement attraction 2600 to another higher or lower portion. In the harnessed section 2602, users are coupled (e.g., via a rope and/or track coupling element) 2604 to the amusement attraction 2600 for safety purposes. As discussed in greater detail herein, the continuous safety or belay system may allow users to traverse among multiple pathways, at the users' discretion, without requiring the users to unhook and/or rehook to the safety or belay system. Although FIGS. 26A-26B illustrate one potential setup or design for the amusement attraction 2600 that includes the harnessed section 2602, in an alternative embodiment, any of a variety of possible setups or designs may be used.

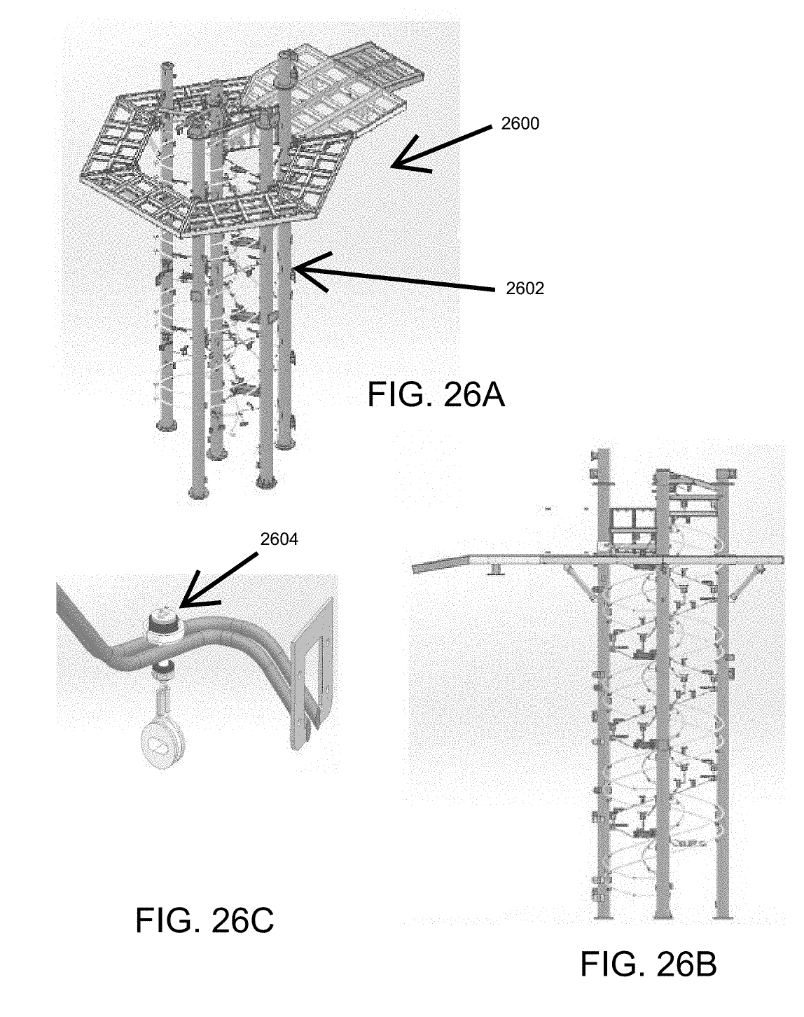

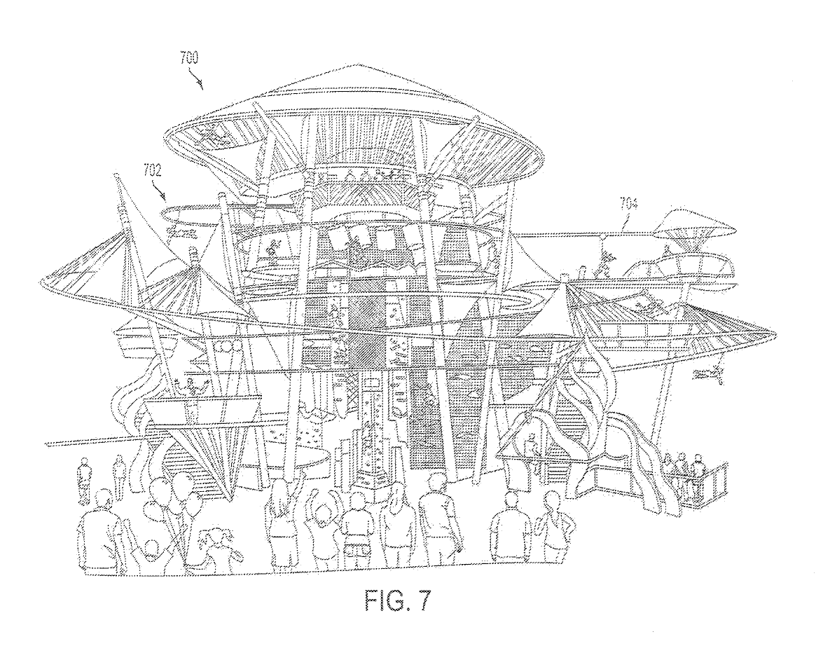

FIG. 7 shows a plurality of views of an amusement attraction 700 including a harnessed section 702 utilizing a continuous safety or belay system, as discussed in greater detail herein, which allows a user to climb, slide, or otherwise interact with a variety of differing features or activities of the amusement attraction 700. In the harnessed section 702, users are coupled (e.g., via a rope and/or track coupling element) to the amusement attraction 700 for safety purposes. As discussed in greater detail herein, the continuous safety or belay system may allow users to traverse among multiple pathways, at the users' discretion, without requiring the users to unhook and/or rehook to the safety or belay system. The amusement attraction 700 may be configured to have a cylindrical shape, wherein users can traverse the harnessed section 702 by circling around the perimeter of the amusement attraction and following branching, harnessed paths 704 to other activities or play areas. Although FIG. 7 illustrates one potential setup or design for the amusement attraction 700 that includes the harnessed section 702, in an alternative embodiment, any of a variety of possible setups or designs may be used.

In certain embodiments, any of the above described features for FIGS. 1-7 (e.g., leaping, traversing, ziplines, etc.) may be incorporated into any of a variety of designs for a desired amusement attraction. Utilizing the continuous safety or belay system, as described in greater detail herein, a user may participate in any and/or all of the features or activities of a given amusement attraction without needing to disconnect or reconnect to the safety or belay system. Thus, users are provided additional freedom to safely traverse an amusement attraction as they desire without being inconvenienced by the design of the safety systems during their traversal of the ride.

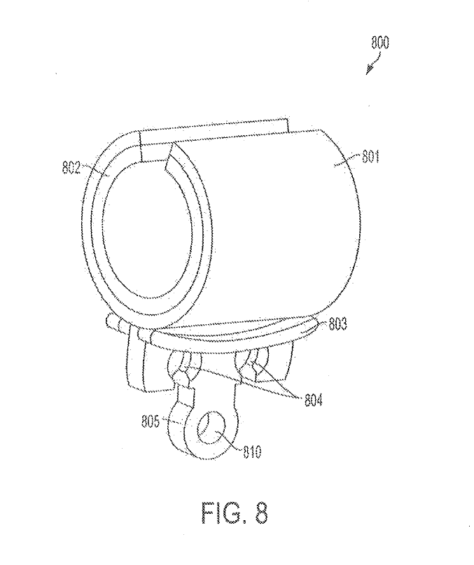

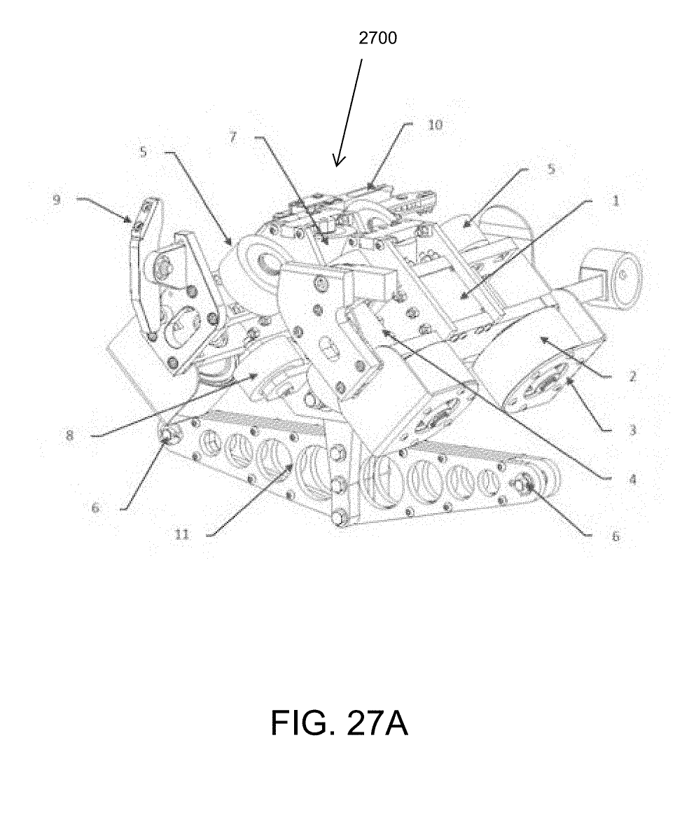

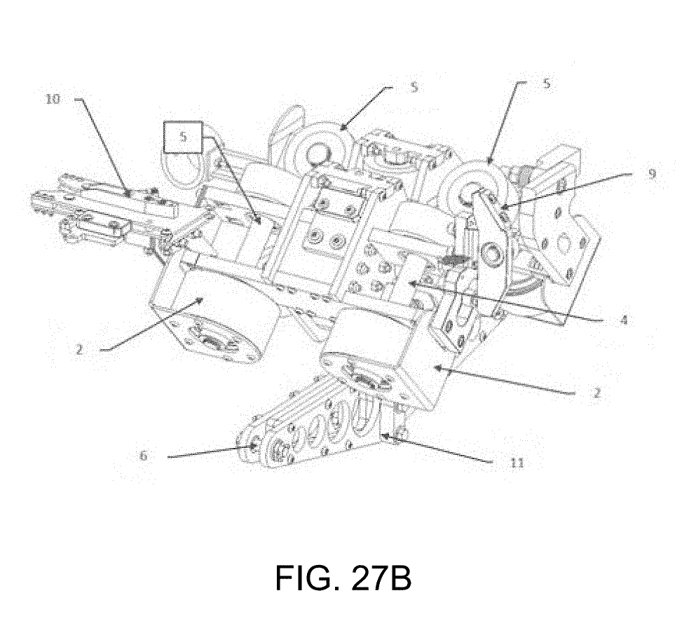

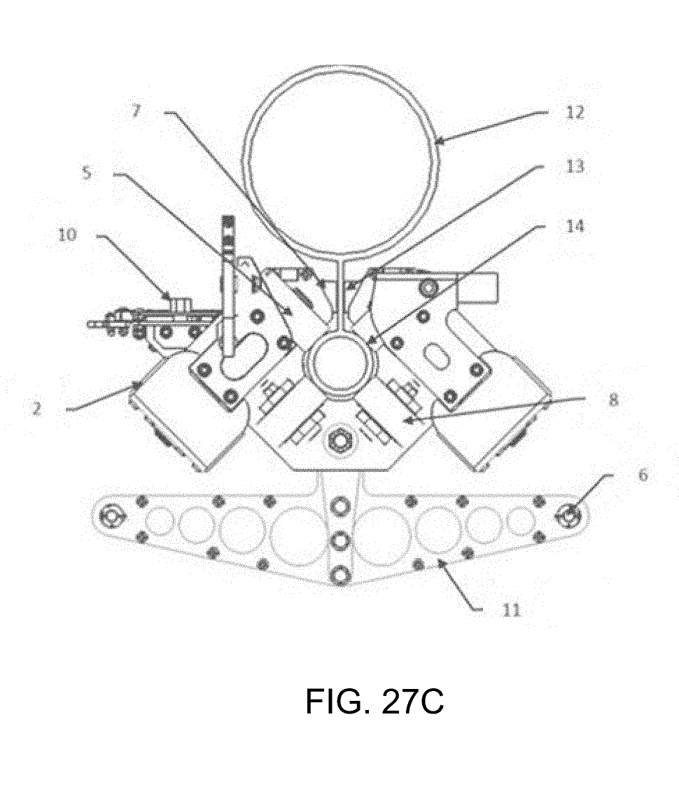

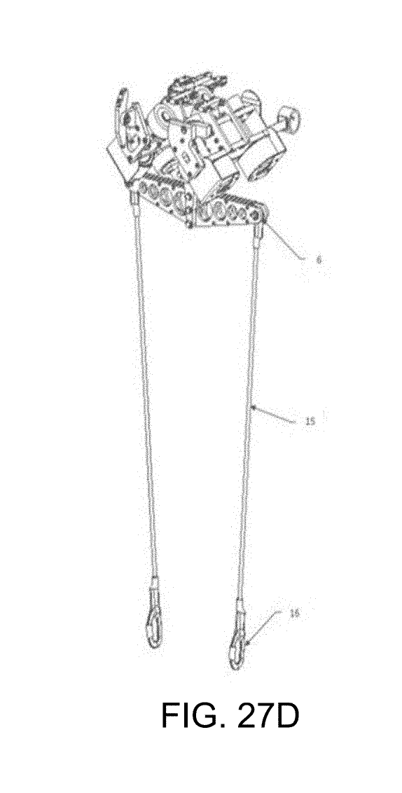

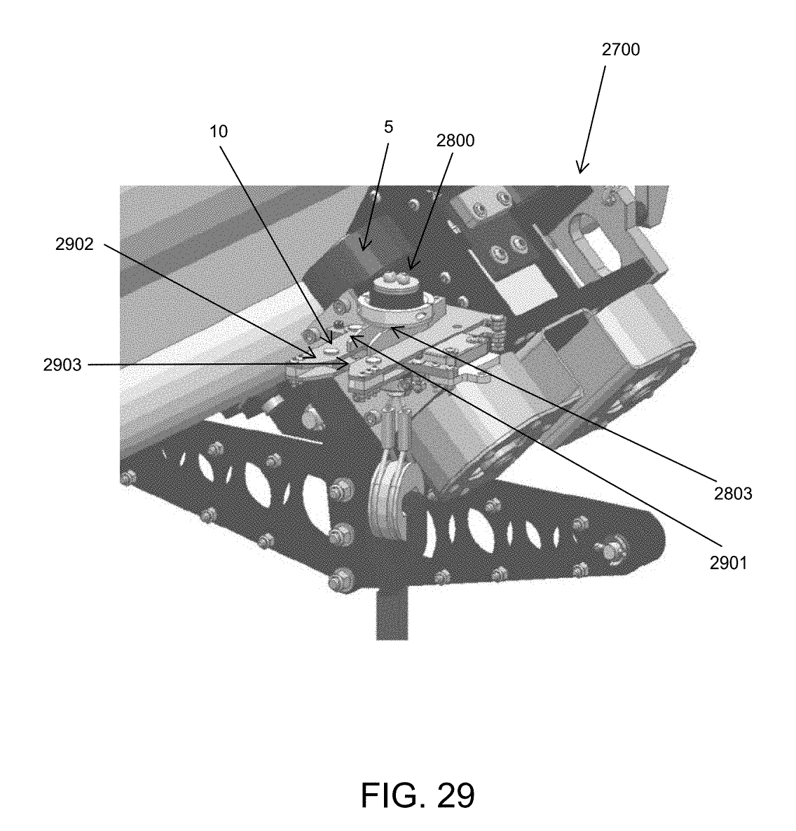

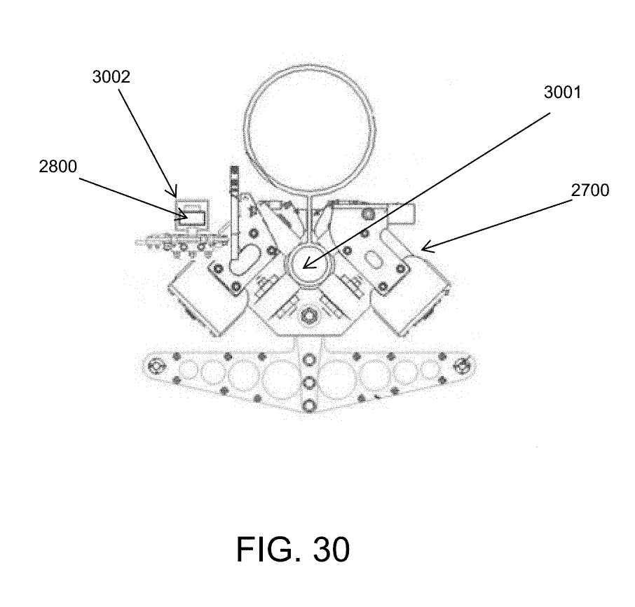

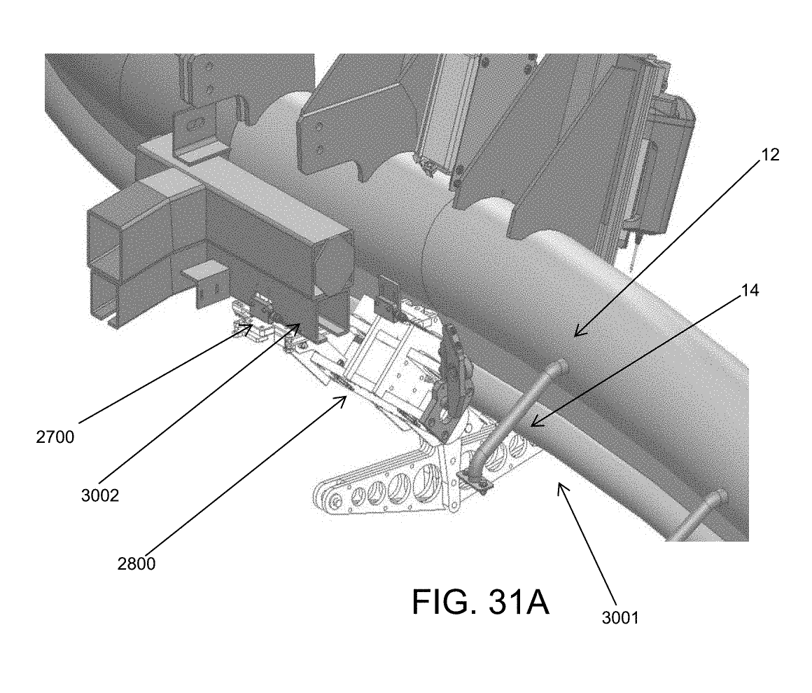

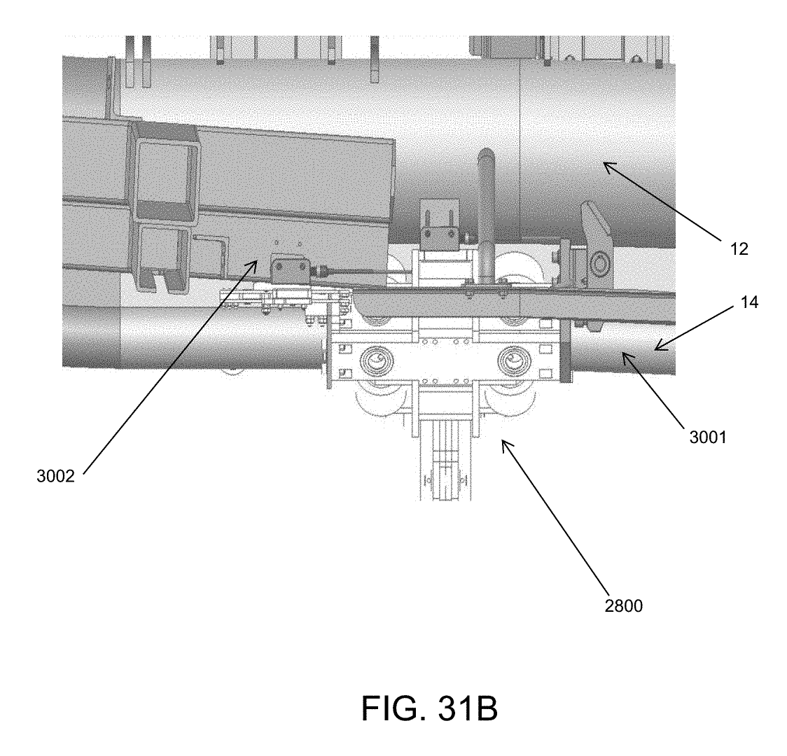

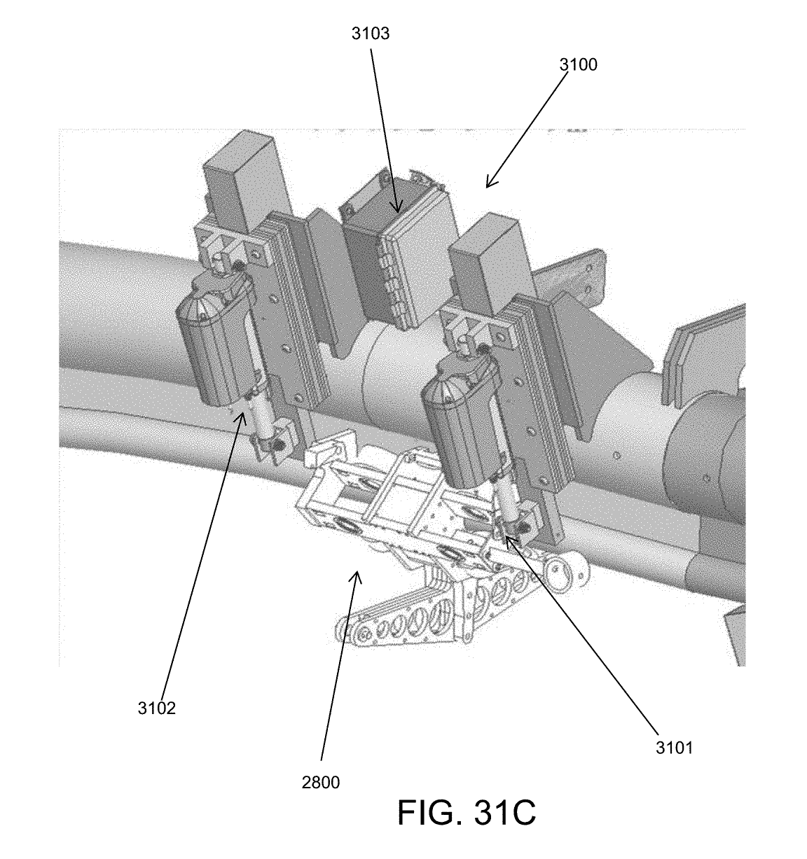

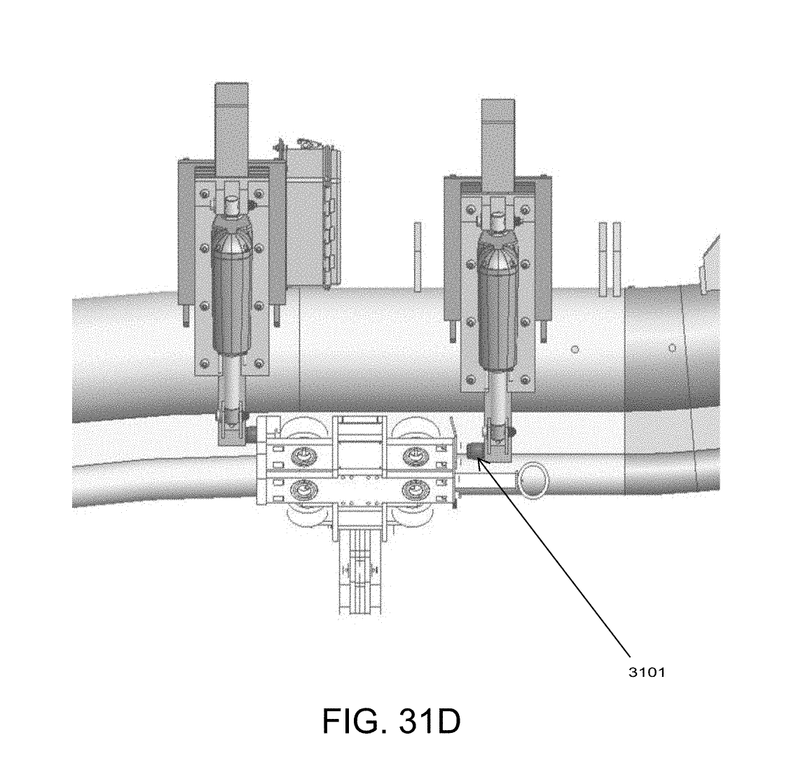

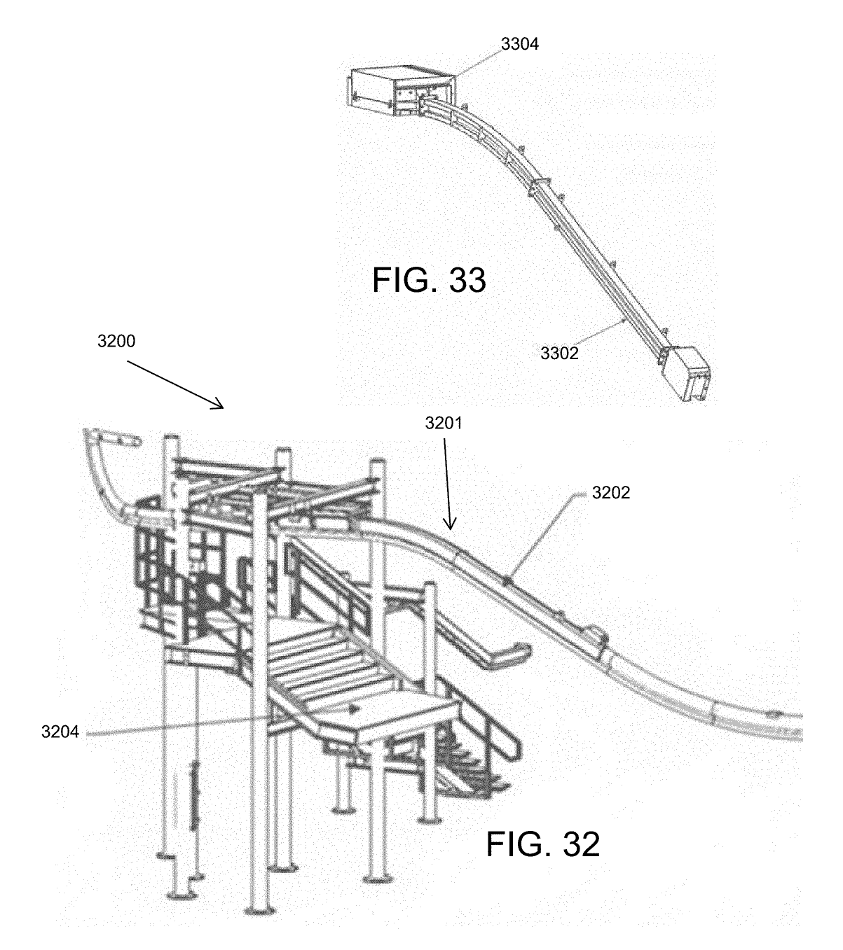

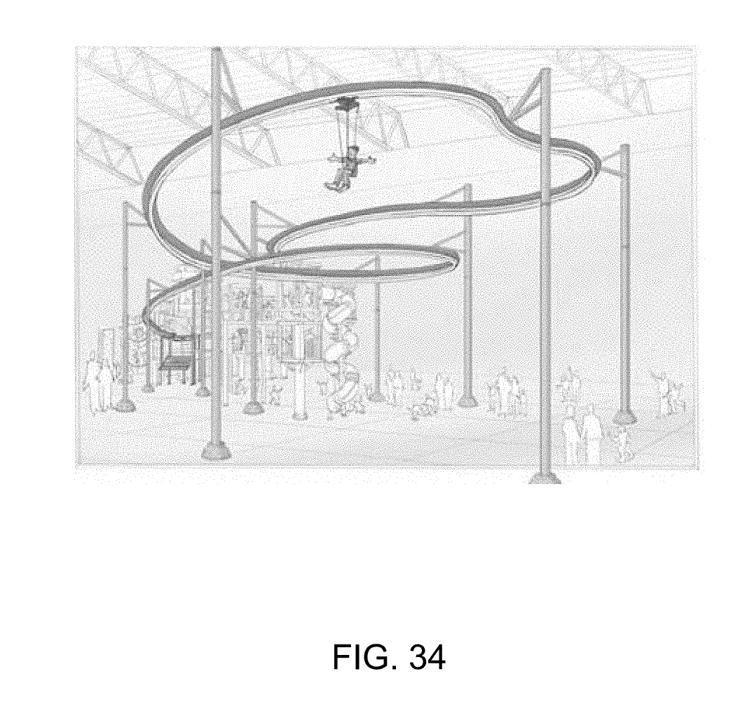

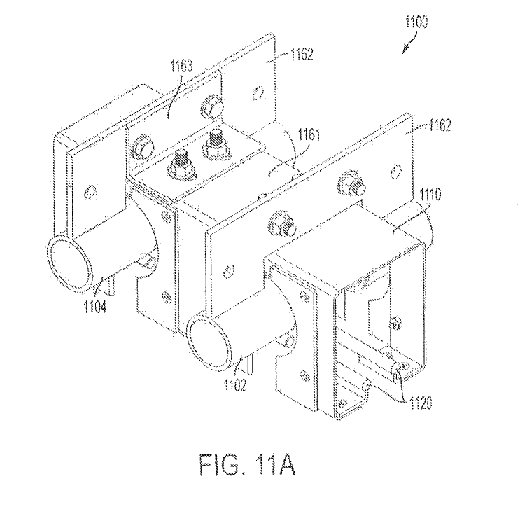

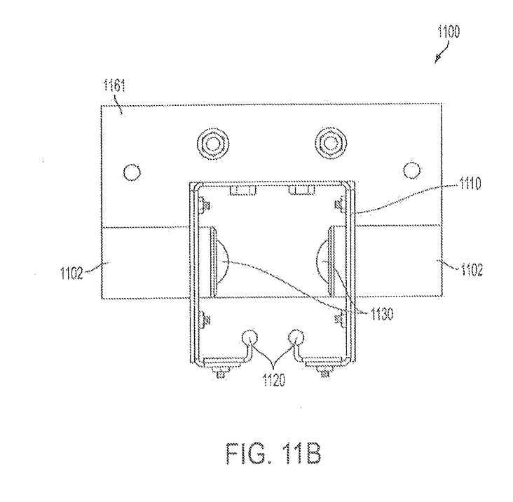

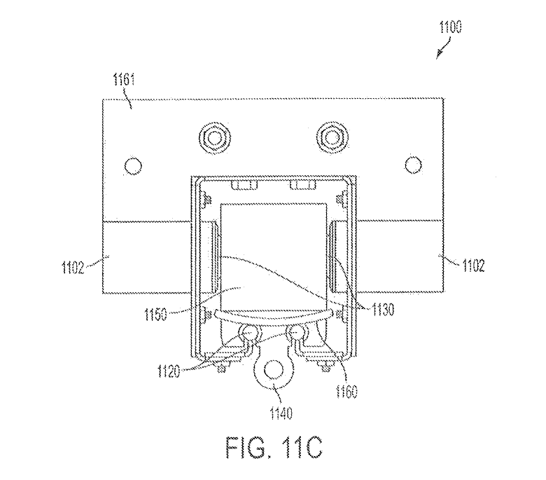

Turning next to FIG. 8, an isometric view of a sliding safety mechanism 800 is shown according to one embodiment of the present invention. The sliding safety mechanism 800 includes a body 801 coupled with a low friction sleeve 802 (e.g., a polymer). The sleeve 802 permits sliding motion of the safety mechanism 800 along a track with reduced friction or wear. A support plate 803 is coupled with the body 801 and provides a surface or component for cooperating with one or more surfaces or components of a junction box or other transitioning structure that is used for transitioning between tracks as desired by the user, for example, as discussed in greater detail herein in FIGS. 11A-11D. An anchor ring 805 that defines an opening 810 is connected with the body 801, for example, via the support plate 803. The opening 810 of the anchor ring 805 permits a user to connect with the safety mechanism 800, for example via a clip and/or rope that also is held, fastened, or otherwise worn by or coupled with the user. A plurality of track keyholes 804 (e.g., in the support plate 803 or in a component connected with the support plate 803) permit the transition from one track to another, as discussed in greater detail below, for example in FIGS. 11 A-11D, through the use of a junction box or assembly.

FIG. 28 shows a perspective of a sliding safety mechanism 2800 according to one embodiment of the present invention. The sliding safety mechanism 2800 includes a body 2801 coupled with a planar surface 2802. The surface 2802 permits sliding motion of the safety mechanism 2800 along a track. The surface 2802 may be a low friction surface (e.g., a polymer) with reduced friction or wear capabilities for facilitate sliding. The surface 2802 may define a support plate that is coupled with the body 2801 and provides a surface or component for cooperating with one or more surfaces or components of a junction box or other transitioning structure that is used for transitioning between tracks as desired by the user, for example, as discussed in greater detail herein in FIGS. 11A-11D. An anchor ring 2805 that defines an opening 2810 is connected with the body 2801, for example, via the support plate 2803. The opening 2810 of the anchor ring 2805 permits a user to connect with the safety mechanism 2800, for example via a clip and/or rope that also is held, fastened, or otherwise worn by or coupled with the user. The sliding safety mechanism of FIG. 28 may or may not include the sleeve 802, such as illustrated in FIG. 8.

As shown, the sliding safety mechanism of FIG. 28 may include a generally cylindrical component defining a lower planar surface for sliding contact on a track. As shown, the cylindrical component is a circular cylinder, but may be any cross sectional shape. On a lower surface, the cylindrical component has an extension projecting from the planar surface. The projection may similarly be cylindrical, but is not so limited. As shown, in use the extension is configured to fit within parallel rails defining a track. The lower planar surface for sliding is configured to have a dimension greater than a separation distance between the parallel rails such that the planar surface simultaneously contacts a top surface of both rails. The extension thereby reduces lateral movement by contacting interior sides of the rails and the safety mechanism is configured to slide in directions along the separation space of the rail.

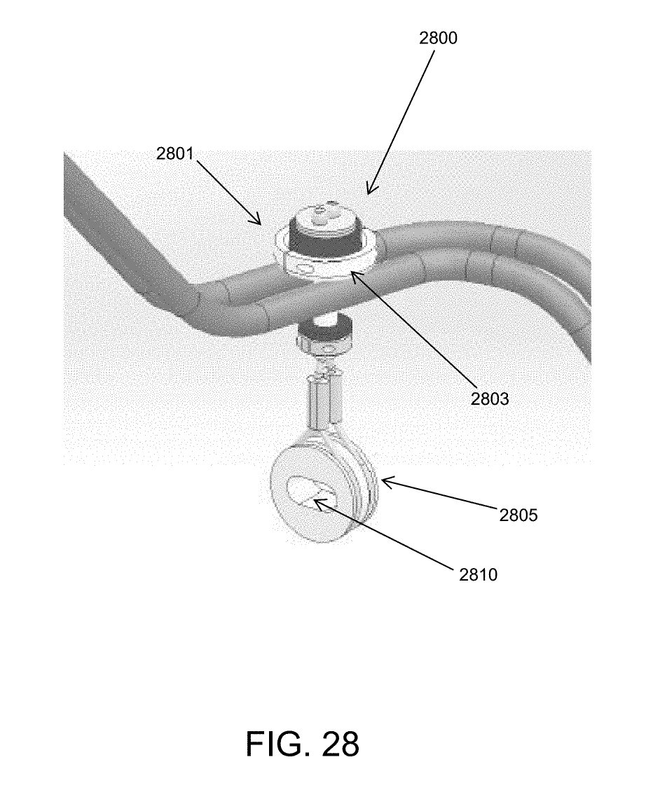

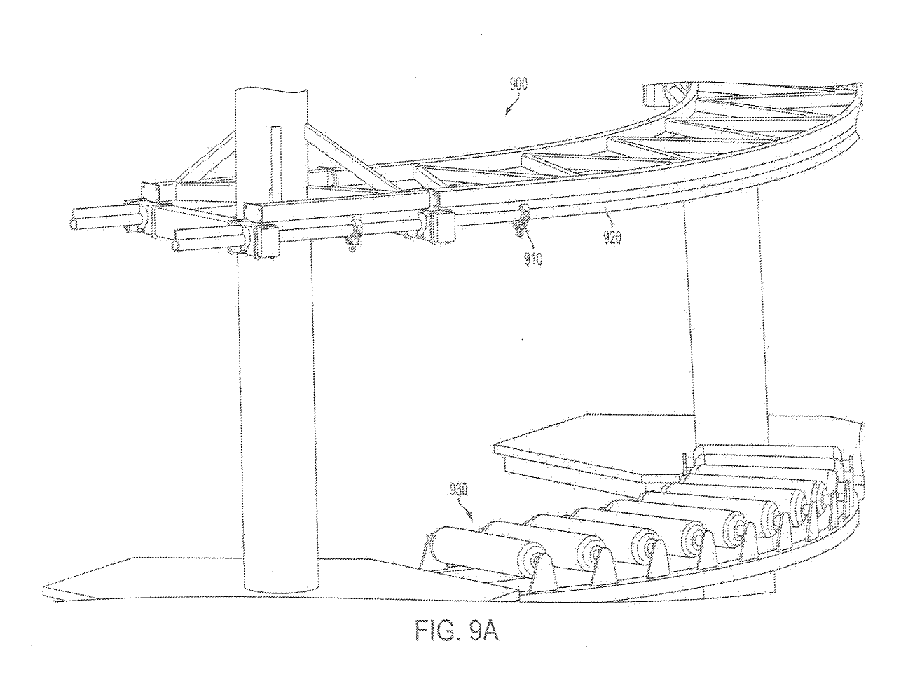

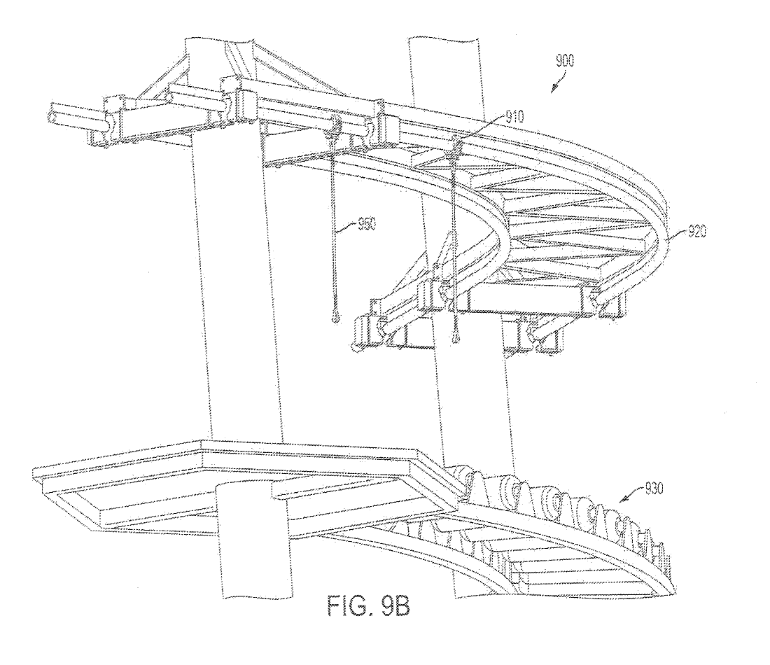

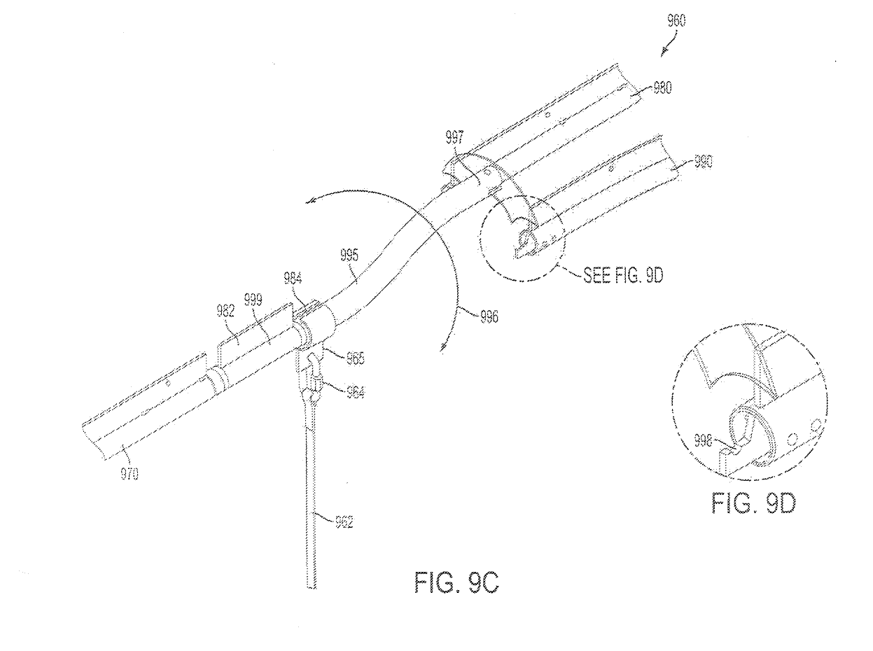

FIG. 9A shows a perspective view of a harnessed section 900 of an amusement attraction or other play structure using a sliding safety mechanism 910. FIG. 9B shows a perspective view of the harnessed section 900 of the amusement attraction using the sliding safety mechanism 910 of FIG. 9A with an attached lanyard 950. With reference to FIGS. 9A and 9B, a user or participant of the harnessed section 900 of the amusement attraction may wear a belt, vest, or other harness that is configured to couple with the lanyard 950 such that the user may traverse on obstacles 930 (e.g., a rope bridge, roller wheels, etc.) while safely connected to a track 920 (e.g., a tubular element) upon which the sliding safety mechanism 910 may slide along (e.g., the track 920 may be configured to be all or partially encompassed by a low friction surface of the sliding safety mechanism 910, for example, the low friction sleeve 802 of FIG. 8). In another embodiment, the track 920 may be any of a variety of shapes or configurations so long as it is permitted to cooperate with the sliding safety mechanism to slide therealong. If the user loses their footing, instead of falling off of the obstacles 930, the sliding safety mechanism 910 and track 920 keep the user from dropping a significant elevation to a lower floor or level, lessening the risk of injury.

FIG. 9C shows a perspective view of a pivoting track system 960 of an amusement attraction that uses a sliding safety mechanism 965. Aspects of the track system 960 and/or the sliding safety mechanism 965 may be the same as or similar to those previously discussed. A user may be connected, for example via a rope or lanyard 962 that connects with a portion of the sliding safety mechanism 965 via a clamp or other connecting element 964. The pivoting track system 960 allows a user to travel along an entrance track 970 via sliding of the sliding safety mechanism 965 and then may choose whether to continue movement along a first exit track 980 or a second exit track 990 via a pivoting portion 995 that is configured to pivot, swivel, twist, or otherwise transfer 996 between the first exit track 980 and the second exit track 990.

In an alternative embodiment, greater numbers of exit tracks may be pivoted between by the pivoting portion 995 and/or alternative methods of moving between exit tracks may be used. The pivoting portion 995 may be moved into position manually by the user as the user travels along the entrance track 970 and/or by staff of the amusement attraction and/or via an electronic system controlled by the user and/or by staff of the amusement attraction. A key notch 998 may be disposed on one or more of the first exit track 980 and/or second exit track 990 that is configured to engage with a protruding element of a connecting end 997 of the pivoting portion 995 in order to facilitate a more secure connection. Bearing supports 999 may be used to provide additional stability or support for the rotating elements of or adjacent to the pivoting portion 995. In certain embodiments, one or more keying walls 982 may be installed along all or a portion of the entrance track 970, first exit track 980, and/or second exit track 990 and cooperate with a notch 984 in the sliding safety mechanism 965 in order to orient the sliding safety mechanism in a desired position (e.g., connecting element 964 downward) as it slides along a track.

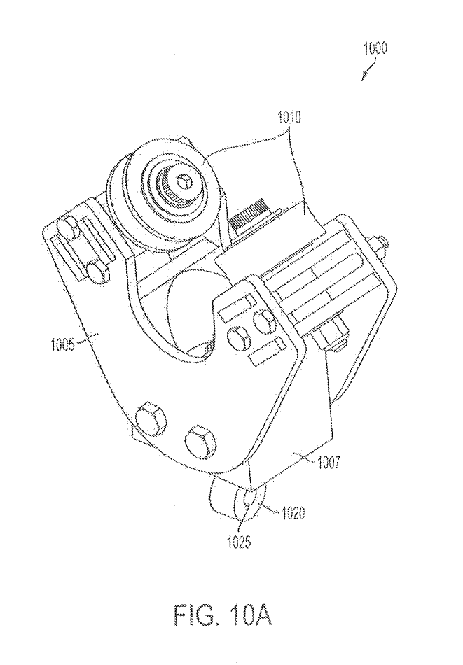

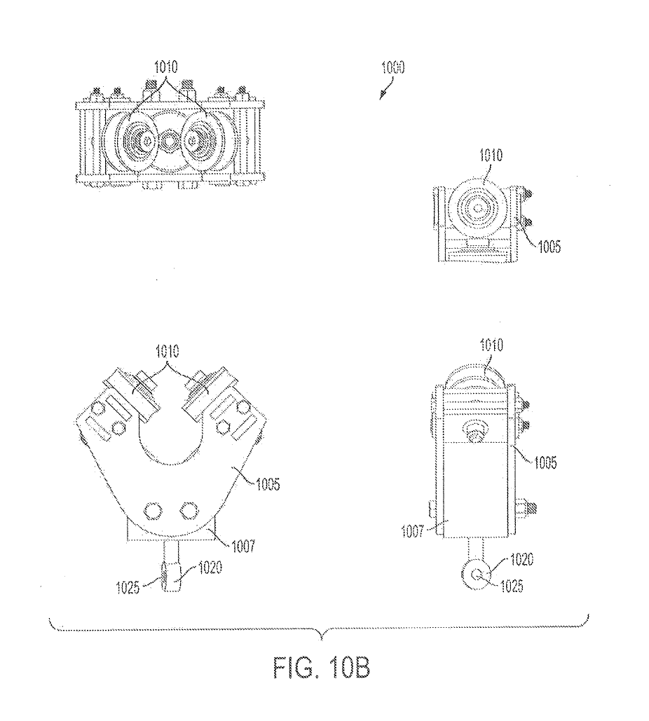

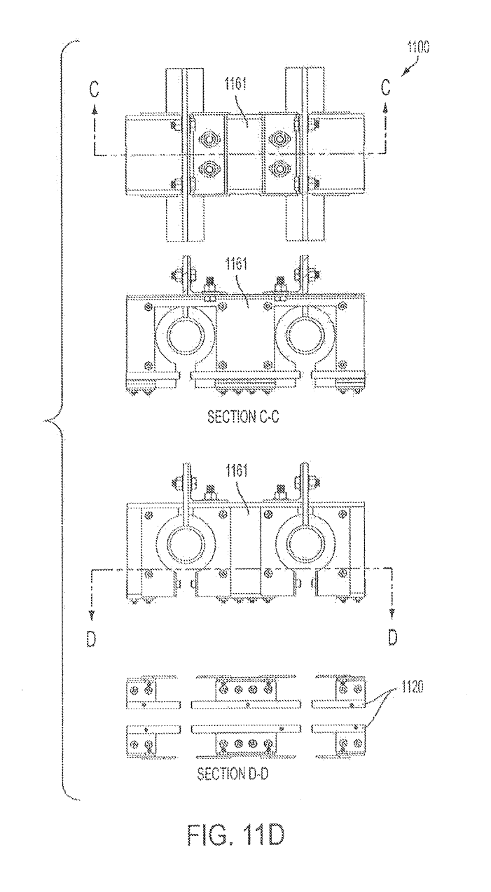

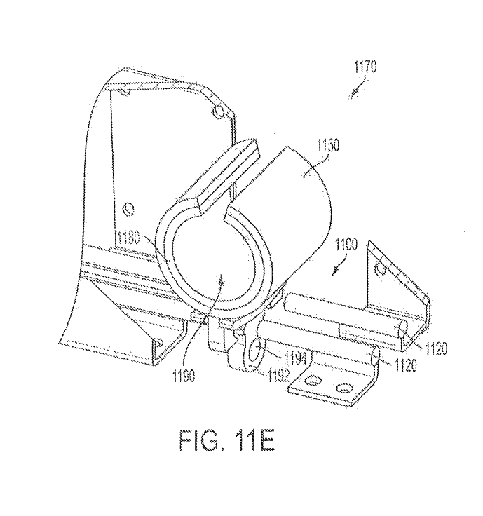

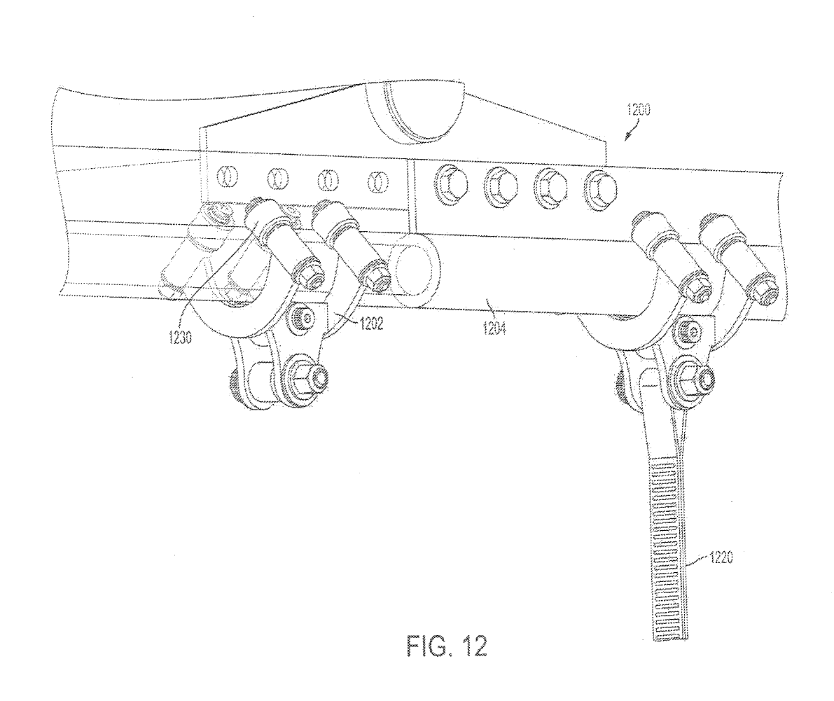

FIGS. 10A and 10B show various views of a rolling safety mechanism 1000. The rolling safety mechanism 1000 may include features or operate in a manner that is the same as or similar to those previously discussed. For example, instead of sliding along a track (e.g., see the sliding safety mechanism 800 of FIG. 8), the rolling safety mechanism 1000 may incorporate one or more rollers 1010 that are configured to rotate or roll along an exterior of a track (see, for example, FIG. 12). In another embodiment, one or more ball-bearings or spherical style rollers may be used. Other aspects of the rolling safety mechanism may be the same as or similar to those safety systems previously discussed (e.g., the rolling safety mechanism 1000 may include a body component 1005 and a connecting plate 1007 that is coupled with an anchor ring 1020 defining an opening 1025 therein for a user to connect to the rolling safety mechanism 1000 via a rope, lanyard, etc.).

FIGS. 27A-27C show various views of a rolling safety mechanism 2700. The rolling safety mechanism 2700 may include features or operate in a manner that is the same as or similar to those previously discussed. For example, instead of sliding along a track (e.g., see the sliding safety mechanism 800 of FIG. 8), the rolling safety mechanism 2700 may incorporate one or more rollers 5 that are configured to rotate or roll along an exterior of a track (see, for example, FIG. 12). In another embodiment, one or more ball-bearings or spherical style rollers may be used. Other aspects of the rolling safety mechanism may be the same as or similar to those safety systems previously discussed (e.g., the rolling safety mechanism 2700 may include a body component 1 and a connecting plate that is coupled with an anchor therein for a user to connect to the rolling safety mechanism 27000 via a rope, lanyard, etc.).

Exemplary embodiments of the safety mechanism may include a speed controller. The speed controller may be incorporated into any exemplary safety mechanism described herein, and is illustrated with respect to the rolling safety mechanism. As best seen in FIG. 27B, each roller 5 is supported to the rigid chassis 1 on independent axles 4. Each roller 5 is coupled to a centrifugal clutch 2 through the axle 4 so that each roller 5 is independent and rigidly coupled to its corresponding clutch 2. Each centrifugal clutch 2 is secured to the chassis 1 using independently mounted anchorage plates 3. The centrifugal clutch is configured to engage nested shafts at higher speeds. During the ride descent the rollers 5 roll on the track 14 turning the axles 4 which in turn drive the centrifugal clutches 2, the housing of which is restrained from rotating by the anchorage plates 3 abutting against the chassis 1. As the speed of the clutches 2 approaches a pre-established maximum rotational speed, the clutches 2 begin to engage creating a torque opposing the rotation of the shafts 4, which is transferred through the axles 4 and to the rollers 5 on the support pipe 14 thus applying a braking force to the safety mechanism and decelerating the rider. The pre-established maximum rotational speed of the clutches 2 is controlled by the selection of the strength of internal springs. The pre-established maximum rotational speed of the clutches 2 is thus used to automatically and passively restrict the maximum speed of the rider while descending or traversing a track to ensure that riders of all weights within a specified height and weight range experience a ride within a pre-determined safe maximum speed. Exemplary embodiments of the speed controller may be used with zip line safety mechanisms to control the maximum speed of a rider down a zip line and toward an exit platform.

Exemplary embodiments of the safety mechanism may include keying features, to align the safety mechanism similar to the keying wall 982 and notch 984 of the sliding safety mechanism described herein. A number of secondary rollers are provided on the exemplary safety mechanism to contact different portions of a track in different orientations to reduce a rotation, or translation of the safety mechanism relative to the track about or along different axis. For example, safety mechanism may include secondary rollers may be used to reduce or prevent the safety mechanism's roll and or secondary rollers may be used to reduce or prevent the safety mechanism's tilt. As shown in FIG. 27C, two pairs of rollers 5 are used to position the vehicle on the track and support the rider, while two secondary rollers act as anti-rotation wheels 7 that abut a keying wall 13 to restrict the vehicle roll. The safety mechanism may also include secondary rollers to act as anti-tilt wheels 8 abutting against the support pipe 14 to restrict the vehicle tilt. Two pairs of anti-tilt wheels 8 are illustrated, but any combination of wheels may be used. Secondary rollers are illustrated herein as an example, but rollers may be replaced with slide surfaces and remain within the scope of the instant description similar to the features described in FIG. 8.

FIG. 27C illustrates an exemplary use of the safety mechanism 2700 on a track according to embodiments described herein. Similar to the rolling safety mechanism 1000 of FIGS. 10A-10B, the rolling safety mechanism 2700 may include one or more rollers 5 that are configured to rotate or roll along an exterior of a track. As shown, two pairs of rollers are provided, however any number of rollers may be used, such as the single pair of FIGS. 10A-10B. The rollers may be provided in a pair to provide rolling contact with the track on opposing sides of the track to maintain the rolling safety mechanism on the track. The rollers 5 may be positioned to contact an upper portion of the track such that the gravitational pull downward or the imposed force of a rider ensure contact of the rollers on an upper surface of the track. As shown, anti-tilt wheels 7 are positioned in pairs and are positioned to contact a lower portion of the track in which the rollers 5 contact. The anti-tilt wheels and the rollers are approximately equidistantly spaced about the circumference of the track, but need not be. As shown, anti-tilt wheels and rollers are configured to contact a circular cylindrical track, but any cross-sectional configuration of track may be used. The track may include a keying wall 13 for aligning and orienting the safety mechanism on the track. The safety mechanism may include a mating feature to the keying wall 13, such as anti-rotation wheels 7 to contact opposing sides of the keying wall. The chassis 1 profile encloses the track such that catastrophic failure of the primary support wheels 5 or axles 4 does not result in the vehicle detaching from the track. The rolling safety mechanism 2700 may also include a rigid chassis 1 that supports the rollers and circumscribes the track, thus ensuring the safety mechanism retains contact with the track even if a component part failures, such as in the event the rollers or axils fail.

As shown in FIG. 27C, an exemplary track for use with a safety mechanism is shown. The track may be a circular cylindrical rail, but any cross-sectional configuration of track may be used. The track comprises a strongback pipe 12 for strength, a continuous guide track 13 to support the anti-rotation wheels 7, and a support pipe 14 to support the primary support wheels 5 and anti-tilt wheels 8. In an exemplary embodiment, the strongback pipe and support pipe are cylindrical. These pipes may define any cross section, although circular cross sections are illustrated for example. The continuous guide attaches between the strongback pipe and support pipe. The continuous guide may define a planar surface and may define any path as defined by the support pipe. As shown, the continuous guide is a vertical sheet extending between the strongback pipe and the support pipe. As shown, the strongback pipe may include one or more larger dimensions, such as diameter and thickness in order to increase the strength of pipe relative to the support pipe.

FIG. 27D shows the exemplary safety mechanism in use with a suspension system for connection to a rider. Exemplary embodiments may be used with a user riding on a zip line or other harnessed or unharnessed activities as described herein. Exemplary embodiments of a suspension system may include two pliable lanyards 15 with integrated or coupled carabiners 16 connected to two connection points 6 symmetrically offset from a center of the safety mechanism on a spreader bar 11. The spreader bar 11 may be connected to the chassis 1 with a pinned connection, allowing lateral swing of the rider within a prescribed maximum arc. The pliable lanyards 15 may permit incidental longitudinal swing of the rider while suspended. The rider may be suspended by the pliable lanyards 15 at a prescribed distance from the safety mechanism to ensure that riders of a specified height and weight range cannot reach the safety mechanism or track during a zip line descent or other certain activities.

Exemplary embodiments may include combinations of the safety mechanism as described herein. For example, a system may include a first safety mechanism configured to traverse a track system as described herein. The first safety mechanism may be configured to attach to a user and permit the user to traverse in different directions without having to unhook and rehook from different safety mechanisms or tracks. The system may include parts of the activity section that poses higher risk or require additional safety mechanisms for providing sufficient support. For example, the activity section may include a zip line having a harness system for supporting a user. The system may therefore include a second safety mechanism configured to traverse the track of a section of the activity section. The second safety mechanism may be configured to engage and/or disengage from the user for use for only a portion of the activity section. In an exemplary embodiment, the first and second safety mechanisms may be configured to mate or otherwise interact such that the user may stay coupled to the first safety mechanism while permitting non-interfering use of the second safety mechanism.

As shown, for example, in FIG. 27B, a safety mechanism 2700 may include a handshake mechanism 10 configured to couple another safety mechanism (not shown) to the safety mechanism. FIG. 29 shows and exemplary connection between a rolling safety mechanism 2700 and a sliding safety mechanism 2800 through the handshake mechanism 10 described herein.

As shown, the handshake mechanism 10 may include a portion that provides a rail configuration in which the sliding safety mechanism may transition from the track to the handshake mechanism. The rail configuration 2901 of the handshake mechanism 10 may include two parallel surface configured to contact the support plate 2803 or lower planar surface of the sliding safety mechanism. The rail configuration 2901 may include a gap between the rails to accommodate the lower projection of the sliding safety mechanism as described herein. The handshake mechanism 10 may include a body 2902 configured to support the sliding safety mechanism 2800. The handshake mechanism 10 may be supported on the body and the body may couple the handshake mechanism to the safety mechanism 2700. The handshake mechanism 10 may therefore permit the removable coupling of one safety mechanism 2800 with another safety mechanism 2700.

In an exemplary embodiment, the handshake mechanism 10 is positioned above and/or to the side of the rolling safety mechanism 2700 to permit unobstructed positioning of a track for the sliding safety mechanism. In an exemplary configuration, the tracks, sliding safety mechanism, rolling safety mechanism, and handshake mechanism are configured and positioned such that a user may be coupled to both the sliding safety mechanism and the rolling safety mechanism; the sliding safety mechanism can be coupled and in contact with a first track system; the rolling safety mechanism can be coupled and in contact with a second track system; the sliding safety mechanism may be engaged in the handshake mechanism and coupled to the rolling safety mechanism; and combinations thereof. For example, the rolling safety mechanism may be in its own track while the sliding safety mechanism is simultaneously coupled to the rolling safety mechanism through the handshake mechanism and to its own track running along the track of the rolling safety mechanism. FIG. 30 illustrates an exemplary embodiment in which a rolling safety mechanism 2800 is on a first track 3001 and a sliding safety mechanism 2700 is on a second track 3002, while simultaneously being coupled to the rolling safety mechanism 2800.

In an exemplary embodiment, the handshake mechanism 10 may include a securing mechanism 2903. The securing mechanism may hold the sliding safety mechanism 2800 within the handshake mechanism 10 of the rolling safety mechanism 2700 until released. The securing mechanism 2903 may be configured to permit access of the sliding safety mechanism in a first direction to couple the two safety mechanism together but prevent disassociation after attachment thereto. The securing mechanism may therefore act as a lock that can be automatically and/or manually engaged. As shown, the securing mechanism 2903 is a spring loaded latch that is configured to rotate and move with the application of a force permitting access into the safety mechanism but to prevent movement or stay stationary upon application of a force in the opposing direction for egress out of the safety mechanism. The spring loaded latch may also be configured to prevent egress or ingress of the sliding safety mechanism into the handshake mechanism of the rolling safety mechanism. The securing mechanism may therefore have an open position to permit ingress and/or egress and a closed position limiting ingress and/or egress into the handshake mechanism. The securing mechanism may be biased in the closed position. The securing mechanism may be positioned in the open position upon manual contact or mated contact with another feature or surface, such as the docking stations as described herein.

In an exemplary embodiment, an amusement attraction may take advantage of a combination of features as described herein. For example, a sliding safety mechanism according to embodiments described herein may be used for a portion of an amusement attraction, while the rolling safety attraction may be used alone or in combination with the sliding safety mechanism for another portion of an amusement attraction. The use of the rolling safety attraction may be used on a portion of an amusement attraction in which the speed of the safety mechanism needs to be controlled and/or when the safety mechanism may require added support, such as when the safety mechanism is supporting the weight of a user. In an exemplary embodiment, the rolling safety mechanism is used for a zip line or similar controlled fall or swing portion of an amusement attraction in which the user's feet are not contacting the amusement attraction.

Exemplary embodiments include methods of using safety mechanisms as described herein. A user may be coupled to a sliding safety mechanism according to embodiments hereby by attaching a tether or harness to a user and the sliding safety mechanism. The safety mechanism then follows the user along a first track system as the user navigates an amusement attraction. The user then comes to portion of the amusement attraction for use with a second safety mechanism. The user may couple the sliding safety mechanism to a rolling safety mechanism to secure the two systems together. The user may then attach additional coupling mechanisms such as tethers or other connectors directly between the rolling safety mechanism and the user. The user may therefore be simultaneously directly coupled to the sliding safety mechanism and the rolling safety mechanism. The sliding safety mechanism may continue to traverse a first track system, while the rolling safety mechanism simultaneously or sequentially traverses a second track system. The sliding safety mechanism and rolling safety mechanism may be simultaneously coupled to independent tracks for a portion of the amusement attraction. The sliding safety mechanism may be supported by the rolling safety mechanism only for another portion of the amusement attraction and be out of contact with the track system. The other portion of the amusement attraction may be a zip line or a controlled fall or slide in which the user is hanging from the rolling safety mechanism. Once through the other portion of the amusement attraction, the sliding safety mechanism may engage and contact a track system simultaneously with the rolling safety mechanism contacting its separate track system. The user may then disengage or decouple from the direct attachment with the rolling safety mechanism and may separate the sliding safety mechanism from the rolling safety mechanism to continue a path along the amusement attraction using the sliding safety mechanism.

In an exemplary embodiment, the amusement attraction may include docking stations to assist with the association between the safety systems. FIGS. 31A-31D illustrate an exemplary embodiment of a docking station for associating two safety mechanisms according to embodiments described herein. FIG. 31A illustrates a first side perspective view of an embodiment of the docking station 3100; FIG. 31B illustrates a side view of the first side of the embodiment of the docking station of FIG. 31A; FIG. 31C illustrates a second side perspective view of an embodiment of the docking station 3100; FIG. 31D illustrates a side view of the second side of the embodiment of the docketing station of FIGS. 31A and 31C.

As shown, the docking station 3100 may include the joining or adjacent positioning of the first track 3001 and second track 3002, such that the rolling safety mechanism 2800 and sliding safety mechanism 2700 are positioned in a desired relative position when the respective safety mechanisms are present on the track. FIGS. 31A and 31B illustrate an exemplary side orientation of showing the relative positions of the different and separate track systems. As seen, the second track system 3002 comes in at an angle relative to the first track system 3001 and then turns such that the two track systems thereafter run approximately parallel. The second track system 3002 is illustrated as being cut away. The second track system 3002 may terminate after a position in which the two safety mechanisms are joined, or may continued and provide a concurrent attachment to the sliding safety mechanism 2700 while the rolling safety mechanism 2800 is engaged.

As shown, the docking station 3100 may include index devices 3101 that retain and position a safety mechanism relative to the racks and/or docking station. As shown, the index devices may lock a rolling safety mechanism within the docketing station. The index device may engage or mate with the safety mechanism to position the safety mechanism in a desired configuration. As shown, for example in FIG. 31C, the index device 3101 may include moveable stoppers. The stoppers may be configured to mate or contact a portion or surface of the rolling safety mechanism 2800. A pair of stoppers may be used to restrict and/or limit forward and/or backward movement of the rolling safety mechanism 2800 relative to the first track 3001 and/or docking station. In an exemplary embodiment, the index device may comprise a mated feature to position the handshake mechanism in an open position to receive a second safety mechanism.

In an exemplary embodiment, the docking station 3100 may include a control system 3103 that permits access into the docking station. The control system 3103 may control the index device 3101 to position the index device relative to the rolling safety mechanism. For example, controller 3103 may control actuator(s) 3102 that move the index device between a first position in which the index device restricts movement of the rolling safety mechanism 2800, and a second position in which the index device is moved relative to the rolling safety mechanism and out of the way of the rolling safety mechanism to permit the rolling safety mechanism to move along the first track 3001. The control system 3103 may communicate to other portions of the system to automatically and/or manually control the index device and/or other portions of the docking station or safety mechanisms.

In an exemplary embodiment, the system may include a turnstile gate that permits users to enter a launch zone. The turnstile gate may be locked to prevent access by a user. The control system may be manually activated by an administrator. The control system may be automatically activated such that access is permitted to the launch zone when the safety mechanism is positioned between the index devices and/or another safety mechanism is not also present in the launch zone. Once access is permitted, the safety mechanism, such as a sliding mechanism coupled to the user, may be configured to slide along a track system that mates and aligns with the rail configuration of the handshake mechanism of the first safety mechanism positioned in the index devices of the docking station.

In an exemplary embodiment, the system may include one or more sensors for detecting a condition and/or position of respective component parts of the system. For example, a sensor 3103 may be a proximity of one or more portions of a safety mechanism. In an exemplary embodiment, the one or more sensors may detect or be used to determine the proximity between one or more portions between different safety mechanism portions. For example, one or more sensors may detect or be used to determine whether the handshake mechanism is in an open condition and/or is engaged with an index device. For example, one or more sensors may detect or be used to determine that a sliding safety mechanism is in proximity to the handshake mechanism and/or within the docking station. For example, one or more sensors may detect or be used to determine that a sliding safety mechanism is engaged with and loaded in the handshake mechanism of another safety mechanism. For example, one or more sensors may detect or be used to determine whether a user is coupled to one or more safety mechanisms. For example, one or more sensors may detect or be used to determine whether a safety mechanism is coupled or in contact with a track system. For example, one or more sensors may detect and or be used to determine whether the index devices are open or closed and/or whether a safety mechanism is positioned in the docking station and/or whether a safety mechanism is locked or open within the index devices.

In an exemplary embodiment, the control system may receive automatic and/or manual inputs. The inputs may control one or more portions of the system. The inputs may be from one or more sensors or components indicating a status of the docketing station. The input may define whether the rolling safety mechanism is positioned within the docketing station. The input may be from a user to request access to the docketing station for a sliding safety mechanism. The input may be from a sensor and/or user indicating a rider is entering a loading zone. The control system may send outputs to control portions of the system. The control system may control one or more access gates or components. The control system may control a position of the index device. The control system may control the handshake mechanism.

In an exemplary embodiment, the system may be configured such that a safety mechanism, such as a rolling safety mechanism is positioned in the docking station and one or more index devices are configured and positioned to lock and/or secure the safety mechanism relative to the docking station. The system is then configured to permit a second safety mechanism, such as a sliding mechanism, to travel along a track system and into a handshake mechanism of the safety mechanism. The safety mechanism is then configured to secure the second safety mechanism relative to the safety mechanism. The system may be configured to permit the two safety mechanisms to simultaneously be positioned on and/or in contact with separate or the same track system. The system is then configured to be actuated an open an index device to permit the safety mechanism to be moved relative to the docking station. The system is configured such that the safety mechanism is configured to translate along a track system. The system may be configured such that the second safety mechanism is or is not in contact with another track system as the safety mechanism translates along the track system. The system may be configured such that the second safety mechanism is engaged with a track system. The system may then be configured to translate the safety mechanism into a docking station and position the safety mechanism between one or more index devices. The system may be configured to close one or more index devices to secure the safety mechanism within the docking station. The system may be configured to permit the disassociation of the safety mechanism from the second mechanism such that the system is configured to permit a user to traverse a track system with the second safety mechanism without the first safety mechanism.

FIG. 32 illustrates an exemplary portion of an amusement attraction including a landing portion of a docking station. As shown, the exemplary track may include an upwardly inclined portion 3201 at a terminal end configured to slow a rider as they approach the end of the track. At the beginning of an exemplary breaking hill, the track curves upward to dissipate the kinetic energy of the safety vehicle traveling along the track. In an exemplary embodiment, the track may include a one way mechanism 3202 for preventing motion of the safety mechanism along the track in a direction opposite the direction of entry, or down the incline of the track. An exemplary one way mechanism 3202 may be a ratcheting pawl mechanism.

In an exemplary embodiment, the system may also include a conveyor 3302 configured to couple to the safety mechanism and move the safety mechanism toward the end of the track so that the user may reach the exit platform 3204. The ratcheting pawl mechanism 3202 may engage with a chain conveyor 332 to prevent the safety mechanism from sliding or rolling down the track or incline of the track. The conveyor chain 3302 may then be used to tow or pull the safety mechanism and the rider to the crest or toward a top of the track incline to a designated landing platform 3204. The system may then be configured such that the safety mechanisms can be transferred to one or more tracks and/or separated from one or more other safety mechanisms and/or from the user according to embodiments described herein.

FIG. 33 illustrates an exemplary embodiment of a conveyor system according to embodiments described herein. The conveyor system 3302 may include a roller chain enclosed in a guide track and an enclosed electrically controlled drive system 3304. Exemplary embodiments of a safety mechanism may include a ratcheting pawl mechanism configured to engage with a chain conveyor 3302 as the vehicle climbs the braking hill during terminal braking at the end of the designated ridepath, preventing the safety mechanism from rolling back down the brake hill and towing the rider to the designated landing and disembarkation point.

As seen in FIG. 27B, an exemplary safety mechanism may include a mechanism 9 for engaging with a conveyor system. As shown, the mechanism 9 may be a ratcheting pawl mechanism configured to engage with a chain conveyor.

Exemplary embodiments described herein may be used to provide a secondary rider connection by anchoring a first safety mechanism to a second safety mechanism using a handshake mechanism or other attachment mechanism. Exemplary embodiments may comprise integrated handshake mechanisms with control systems to retain and release one safety mechanism from another at designated portions to safely transfer the rider without disconnecting from a continuous belay system.

Exemplary embodiments described herein may include a configurable track. The track may be configurable by permitting a user to selectively engage or traverse selectable track routes according to embodiments described herein. The track may also or alternatively be configurable at a design and implementation stage such that portions of the track may be selectively coupled to define a desired track path and/or experience. For example, FIG. 34 illustrates an exemplary configurable zip coaster track according to embodiments described herein. The configurable track may be one that is configurable and custom designed for any or a specific site. The system may include modular, prefabricated components for coupling together in a desired configuration to create a unique and custom design track for implementation for a specific site using common components. As shown, the modular zip track may comprise a plurality of track components and a plurality of support components. The support components may be one or more vertical supports including an anchor at the bottom to maintain the support in an upright position and an attachment for coupling the track to the support. The track may include a plurality of track portions that mate together to define a track path. The track and/or supports may be configurable to a location and may or may not integrate or wrap around other play structures.

FIGS. 11A-11D show various views of one embodiment of a junction box 1100 that allows a user to transition from a first track to a second track in an amusement attraction without requiring the user to unhook from and/or rehook to a safety or belay system in conjunction with the transition. In one example, the junction box 1100 may be configured to operate with a sliding safety system, such as the sliding safety system 800 previously described for FIG. 8. Certain features of the junction box 1100 may also be used in an alternative embodiment that works with other safety system designs (e.g., the rolling safety system 1000 previously discussed). The junction box 1100 and any associated sliding safety system may include features that are the same as or similar to those previously discussed.

Particularly, FIG. 11A shows a perspective view of the junction box 1100. FIG. 11B shows a side view of the junction box 1100 without a safety or belay mechanism contained therein while FIG. 11C shows a side view of the junction box 1100 with a safety or belay mechanism contained therein. A first track 1102 may be disposed such that a user sliding therealong can travel to a first activity or feature of an amusement attraction that lies along or is contiguous with the first track 1102 and a second track 1104 may be disposed such that a user sliding therealong can travel to a second activity or feature of the amusement attraction that lies along or is contiguous with the second track 1104.

A user that is sliding along the first track 1102 via a sliding safety system (e.g., the sliding safety system 800 of FIG. 2) may wish to transfer from the first track 1102 to the second track 1104 in order to travel to the second activity or feature. In a conventional safety or belay system this would not be possible unless the second activity or feature was already located at a position along the first track 1102 and/or would require the user to disconnect from the safety system and/or the first track 1102 and reconnect to the safety system and/or the second track 1104.

As shown in FIG. 11A, however, the junction box 1100 operates to permit the user connected with the sliding safety system to interface with one or more lateral support tracks 1120 that extend at an angle (e.g. perpendicular, as illustrated) to the first track 1102 and/or the second track 1104. In an alternative embodiment, any of a variety of angles to the first track 1102 and/or the second track 1104 may be possible for disposition of the one or more lateral support tracks 1120. In this manner, keyholes in the sliding safety system (e.g., keyholes 804 as shown in FIG. 8) may cooperate with the one or more lateral support tracks 1120 to allow the user to transition from the first track 1102 to the second track 1104, or vice versa, without having to perform any disconnections from the sliding safety system.

For example, when the lateral support tracks 1120 are disposed within the keyholes 804, the support plate 803 may rest and therefore slide on top of the lateral support tracks 1120 to the desired main track. In one embodiment, a low-friction surface (e.g., a coating or mechanical component, such as ball bearings) may be disposed upon a lower surface of the support plate 803 to accommodate lower friction sliding on top of the lateral support tracks 1120. After traversing along the lateral support tracks 1120 to a desired main track (e.g., the first track 1102 or the second track 1104), the user may engage with such track and continue along its pathway (e.g., via a low-friction sleeve, such as sleeve 802, that encompasses all or a portion of the track, as seen in FIG. 8). The junction box 1100 may have a body component 1161 (e.g., composed of various pieces welded, screwed, bolted, or otherwise fastened together) in order to align the various main tracks and/or support tracks in a desired orientation. One or more track mounts 1162 with one or more track mount support brackets 1163 may connect the body 1161 of the junction box 1100 with a desired track or portion of the amusement attraction.

With reference to FIGS. 11B-11D, in one example, operation allows a participant to navigate an aerial challenge course. The participant is secured in a harness (e.g., a full-body harness) that is attached with a lanyard to a sliding belay mechanism 1150 (see FIG. 11C), such as the sliding safety system 800 of FIG. 8, via an anchor ring 1140 (see FIG. 11C), such as the anchor ring 805 of FIG. 8. The sliding belay mechanism 1150 slides along a track (e.g., horizontal or nearly horizontal), that may be manufactured of round tubing, above or through various challenge elements of the amusement course. In one embodiment, the track may feature curves and/or direction changes (e.g., with radiuses greater than 20 inches). The sliding belay mechanism 1150 can feature low-friction features (e.g., the low friction sleeve 802 of FIG. 8) or rolling elements (e.g., as discussed in FIG. 9) in order to secure and smoothly travel along the track. In one embodiment, the track may be supported directly above via a welded full-length section of vertically oriented flatbar that is bolted to supporting structures. In such an embodiment, the sliding belay mechanism 1150 may feature a gap in order to clear this flatbar when traveling adjacent to it along the track.

The participant is allowed to safely transition between one or more (e.g., parallel) tracks, such as the first track 1102 and the second track 1104, while under continuous, passive belay at the junction box 1100. As the sliding belay mechanism 1150 enters the junction box 1100, one or more curved support plates 1160 (e.g., support plate 803 of FIG. 8) engages on the top of the lateral support tracks 1120 as the sliding belay mechanism 1150 travels through a gap between the lateral support tracks 1120 to the centerline of the junction box 1100. As the sliding belay mechanism 1150 enters the centerline of the junction box 1100, it leaves the track and is supported by the one or more support plates 1160. A clamp is positioned by sprung detent ball plugs 1130 (see FIG. 11B) to help prevent twisting.

Once at the centerline of the junction box 1100, the keyholes (e.g., keyholes 804 as shown in FIG. 8) in the sliding belay mechanism 1150 line up with the lateral support tracks 1120 and the sliding belay mechanism 1150 can now travel along the pathway defined by the lateral support tracks 1120 (e.g., perpendicular to the main track) under passive, continuous belay. Once at the centerline of the intended track (e.g., the first track 1102 and/or the second track 1104), the sliding belay mechanism 1150 is positioned using the spring detent ball plugs 1130. The sliding belay mechanism 1150 can now exit the junction box 1100 through a gap in the lateral belay tracks 1120.

FIG. 11E shows a perspective cut-away view of the use or operation 1170 of the safety or belay mechanism 1150 with a junction box 1100. The safety or belay mechanism 1150 may include features, uses, and/or operation that are the same as or similar to those previously discussed, for example, the sliding safety mechanism 800 of FIG. 8. As illustrated, and with reference to the above discussion for FIGS. 11A-11D, the safety or belay mechanism 1150 includes a sleeve 1180 defining an opening 1190 that is configured to slide along a track (e.g., a tubular element or a desired radius). An anchor ring 1192 defines an opening 1194 therein, the opening 1194 configured to cooperate with a clip or other fastening mechanism that is coupled with a lanyard. A user may be connected with an opposing end of the lanyard. When within the junction box 1100, the safety or belay mechanism 1150 slides along one or more lateral support tracks 1120 in order to transition between main track components. Once the safety or belay mechanism 1150 is lined up with a main track component, the safety or belay mechanism is configured to mate with the main track component via the opening 1190 of the sleeve 1180 and travel on the main track component, disengaged from the lateral support tracks 1120.

FIG. 12 shows a perspective view 1200 of a rolling safety mechanism 1202 on a tubular track 1204. The rolling safety mechanism 1202 and/or the tubular track 1204 may include features that are the same as or similar to those previously discussed. As shown, a plurality of rolling elements 1230 are configured to cooperate and roll along the track 1204 such that the rolling safety mechanism 1202 travels down the track 1204 with a user with reduced friction. Any of a number of rolling elements 1230 in a variety of configurations (e.g., ball bearings coupled with a surface that makes contact with an exterior of the track 1204) may be implemented in alternative embodiments. The user may be connected to the rolling safety mechanism 1202 by any of a variety of connection means, such as a lanyard 1220 with or without a connecting plate (e.g., which may allow the user to pivot via a pivoting connection and/or slide within the connecting plate (such as via a slot) or any of a variety of other connecting components (e.g., standardized components, off-the-shelf components, and/or a variety of other specific or specialized connecting components).

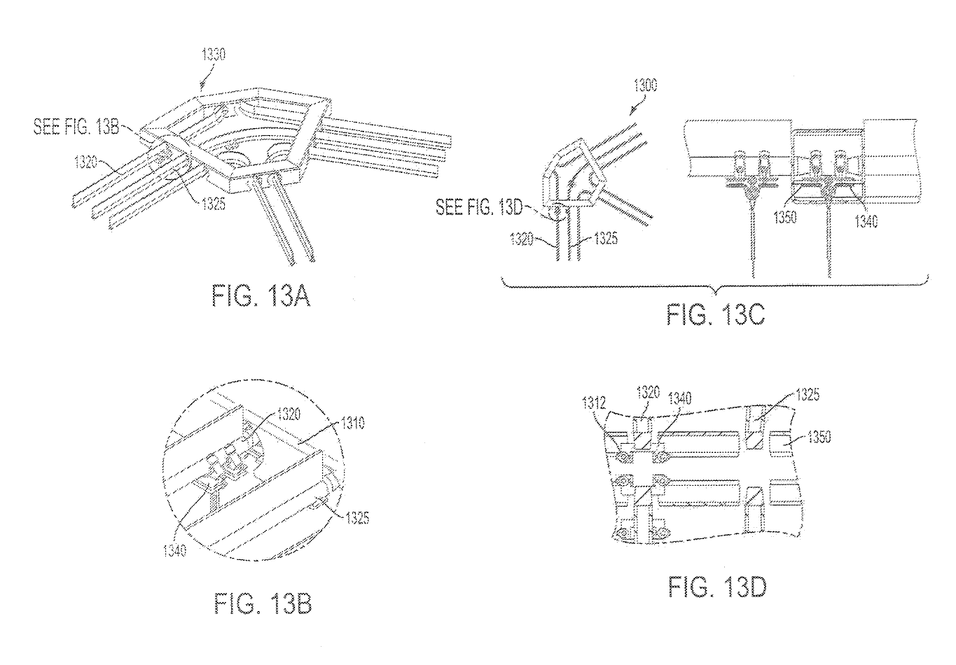

FIGS. 13A-D shows a plurality of views 1300 of a rolling safety mechanism 1310 (e.g., a trolley) configured to roll along one or more tracks (e.g., first track 1320 and second track 1325) and cooperate with a junction box 1330 in an amusement attraction. The rolling safety mechanism 1310, the first track 1320, and/or the junction box 1330 may include features that are the same as or similar to those previously discussed. As shown, the rolling safety mechanism 1310 includes a plurality of rolling elements that make rolling contact with the first track 1320 so that the rolling safety mechanism may travel along the first track 1320 with a user. Upon encountering the junction box 1330, a user connected with the rolling safety mechanism may choose among a plurality of tracks with which to connect.

In one embodiment, as shown, the rolling safety mechanism 1310 includes one or more support plates 1340 (e.g., indexing plates) that are configured to make contact with one or more translation rails 1350 that are positioned laterally or otherwise adjacent and/or between tracks of the amusement attraction in the junction box 1330. For example, if the rolling safety mechanism 1310 is traveling along the first track 1320 and, upon reaching the junction box 1330, the user decides to switch to the second track 1325, the user may cause the rolling safety mechanism 1310 to travel along the translation rails 1350 via sliding contact with the support plates 1340 until the rolling safety mechanism 1310 is lined up with the second track 1325. At this time, the user may cause the rolling safety mechanism 1310 to travel along the second track 1325 and the rolling safety mechanism 1310 no longer makes contact with any translation rails 1350 via the support plates 1340. In certain embodiments, friction may be lessened during the sliding contact of the support plates 1340 and the translation rails 1350 (e.g., ball bearings may be coupled or embedded with the support plates 1340 and/or translation rails 1350, low friction materials may be used or applied to the support plates 1340 and/or translation rails 1350, etc.).

Any of a variety of track shapes or configurations may be used in conjunction with the junction box to allow a user to choose a desired path for travel in the amusement attraction. For example, straight tracks may be used, or the tracks may be curved, for example, as shown. The user may choose to engage with any of a variety of tracks by traversing along the translation rails 1350 of the junction box 1330.

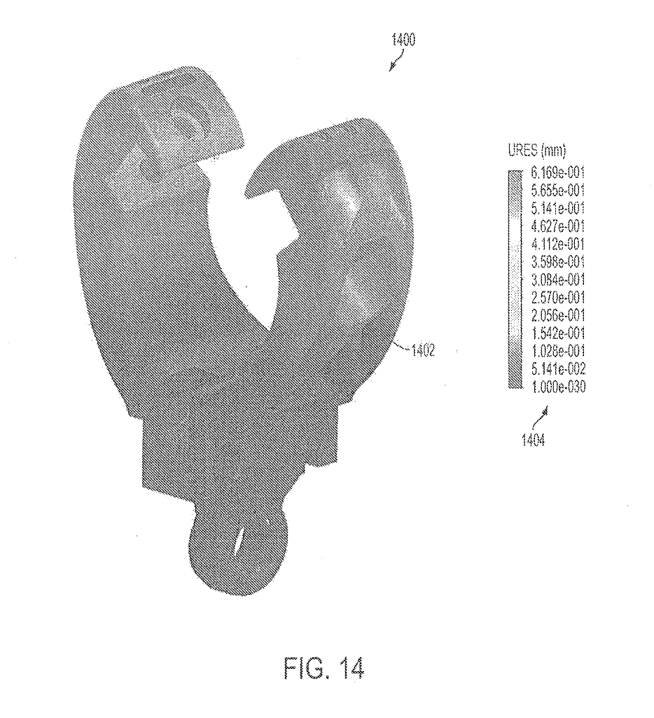

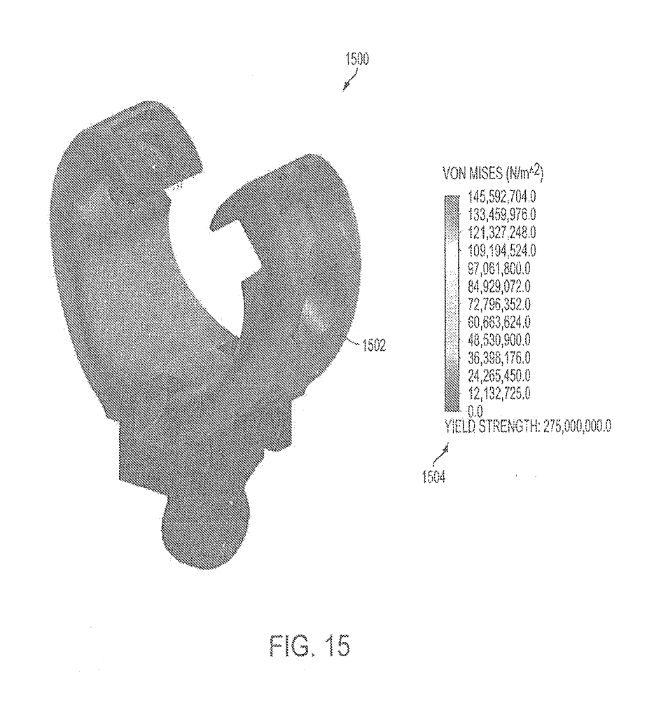

FIG. 14 shows a perspective view 1400 of a body 1402 for a rolling safety mechanism with corresponding URES displacement test data 1404. The body 1402 of the rolling safety mechanism may include features that are the same as or similar to those previously discussed. FIG. 15 shows a perspective view 1500 of a body 1502 for a rolling safety mechanism with corresponding static nodal stress test data 1504. The body 1502 of the rolling safety mechanism may include features that are the same as or similar to those previously discussed. Certain embodiments of rolling safety mechanisms utilizing URES data and/or stress data that complies with the same or similar values to these shown may provide certain desirable features (e.g., additional strength) for use in certain amusement attractions configurations.

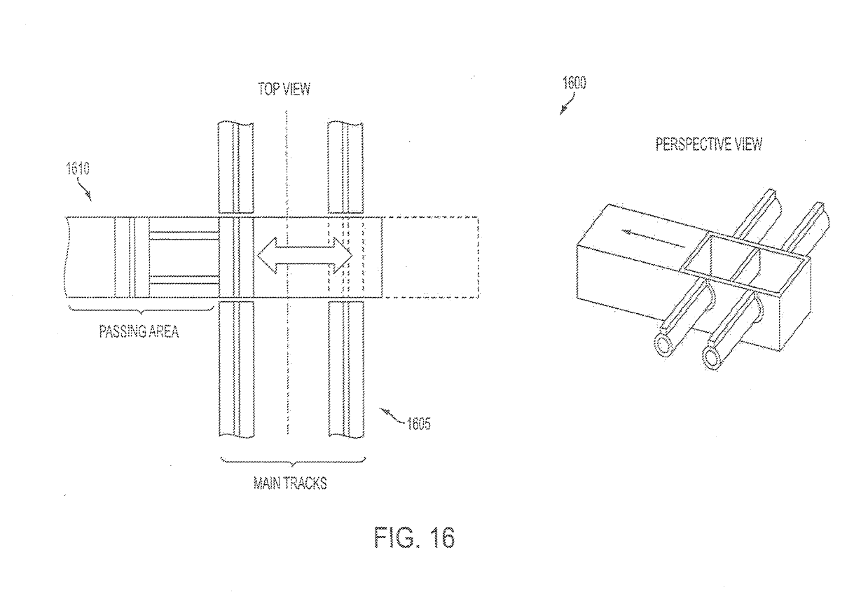

FIG. 16 shows a plurality of views of a passing box 1600 for use with a safety or belay mechanism. The passing box 1600 and/or the safety or belay mechanism may include features that are the same as or similar to those previously discussed. For example, the passing lane box may include features of the previously described junction boxes such that a user can opt to change to a different track without unhooking from a safety device while on an amusement attraction. In this manner, a user who is behind another user on a track 1605 of an amusement attraction need not wait for the user in front of them to finish their activity or move out of the way. Instead, the user in back may choose to pass the front user by switching to a parallel or other track. Alternatively, the passing box may allow for the user in front to transfer out of the way of a user behind them to a waiting track or space 1610 and wait for such user to pass before switching back to the original track 1605 and continuing with their activity. Such switching may be aided by gravity such that the user can begin movement towards the other track at a junction point and gravity will aid in securing the safety or belay mechanism to other track.

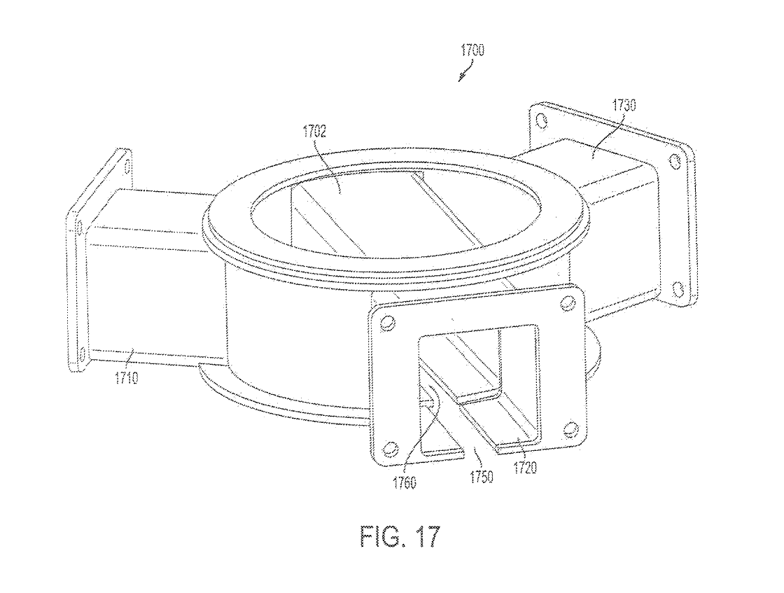

FIG. 17 shows a perspective view of a rotating junction box 1700 for use with a safety or belay mechanism according to one embodiment of the present invention. The turntable box 1700 and/or the safety or belay mechanism may include features that are the same as or similar to those previously discussed. For example, the turntable box may include features of the previously described junction boxes or passing boxes such that a user can opt to change to a different track without unhooking from a safety device while on an amusement attraction. The turntable box 1700 may have a rotatable portion 1702 (e.g., in its center) such that a user connected with the safety or belay mechanism (e.g., that cooperates with a slot 1750 in a first track 1720 of the turntable box 1700) can slide along one the first track 1720, encounter the rotatable portion 1702 of the turntable box 1700, and then rotatably choose a new track (e.g., second track 1710 or third track 1730) to travel along.

Any of a number of possible new tracks may be selectable by the user or staff member for an amusement attraction in an alternative embodiment, either via manual rotation or electronic rotation). In one example, a user may slide along the first track 1720 and position the safety or belay mechanism into a slot 1760 in the rotatable portion 1702. The user may then manually rotate (e.g., via crank, a connected electronic system that is manipulatable via user control such as a button or switch, or via the user's own body movement or inertia), or the turntable will automatically rotate, the rotatable portion 1702 such that the slot 1760 of the rotatable portion 1702 lines up with a slot (not shown) of the second track 1710 or the third track 1730. The user may then continue travel along such chosen track.

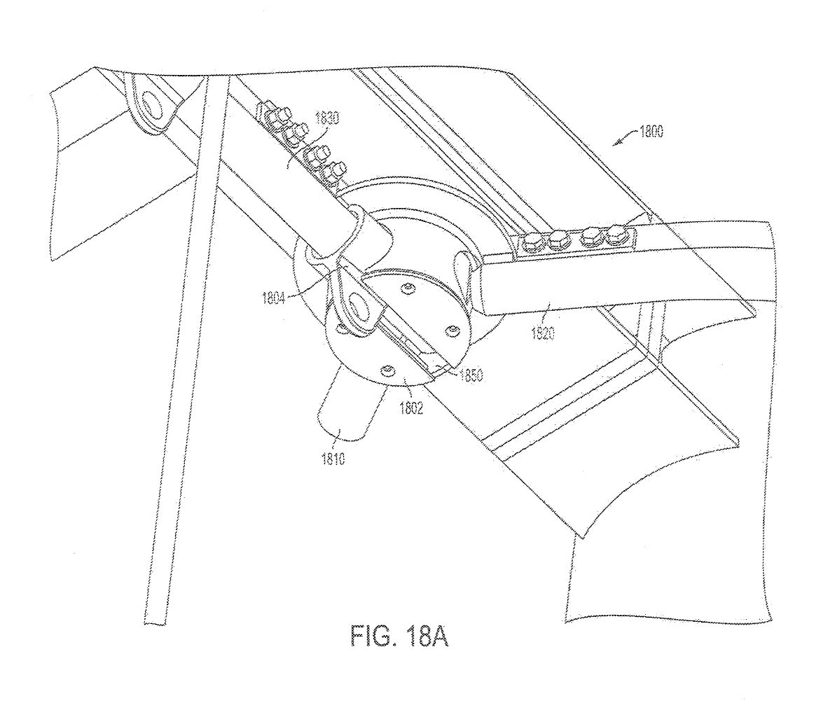

FIG. 18A shows a bottom perspective view of a slider clamp track 1800 with a rotatable component 1802 for use with a safety or belay mechanism 1804. The slider clamp track 1800 with the rotatable component 1802 and/or the safety or belay mechanism 1804 may include features that are the same as or similar to those previously discussed, for example, the turntable box 1700. In this fashion, a user may choose a desired track (e.g., tracks 1810, 1820, 1830) for which to travel along while on an amusement attraction, without having to unhook from the safety or belay mechanism 1804 and/or disconnect/reconnect the safety or belay mechanism 1804 between tracks (1810, 1820, 1830). A slot 1850 in the rotatable component 1802 provides access for the downwardly extending portion of the safety or belay mechanism 1804 that cooperates with a lanyard or other connecting element in order to fasten to a user. FIG. 18B shows a perspective view of the slider clamp track element 1800 of FIG. 18A with the rotatable component 1802 for use with a safety or belay mechanism 1804.

FIG. 18C shows an exploded perspective view of the slider clamp track element 1800 with a rotatable component for use with a safety or belay mechanism. As shown, this may include a top component 1860 that mates with a connecting ring 1870 for interaction within a main body component 1880. The main body component 1880 provides an interface with one or more tracks (three illustrated here) that a user may choose to slide therealong using the safety or belay mechanism. The top component 1860 connects with a bottom component 1890 that contains a slot therein (the same as or similar to the previous discussion) which provides space for a downwardly extending portion of the safety or belay mechanism that cooperates with a lanyard or other connecting element in order to fasten to the user. Thus, the top component 1860 and the bottom component 1890 are permitted to rotate with respect to the main body component 1880 (e.g., within an interior perimeter or cutout of the main body component 1880 so that a desired track among a plurality of tracks may be selected for travel.

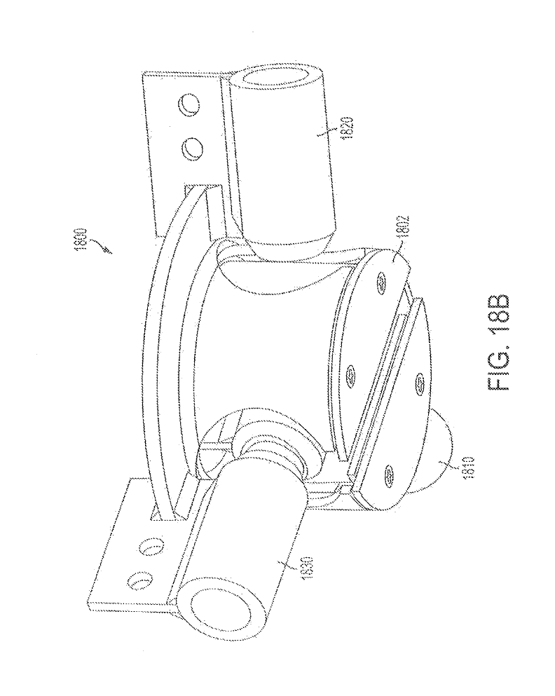

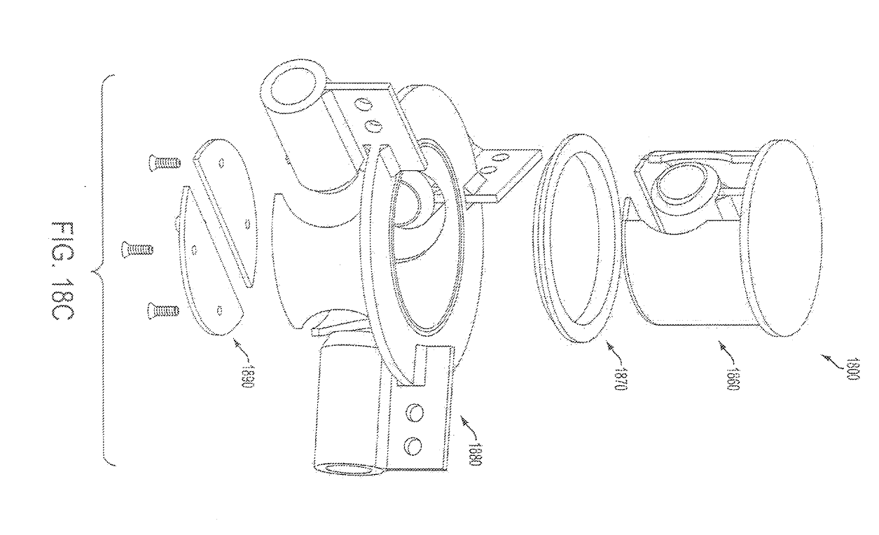

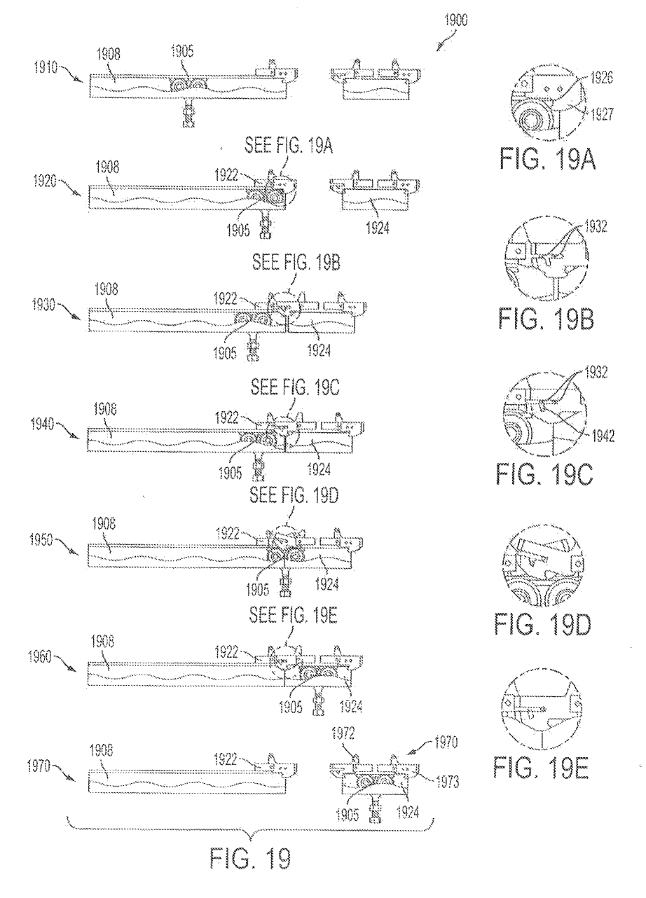

FIG. 19 and corresponding FIGS. 19A-19E shows a schematic describing a handshake operation 1900 for an amusement attraction utilizing a safety or belay mechanism. At schematic step 1910, a trolley 1905 is located on a fixed, main section of track 1908. At schematic step 1920, at the end of the track 1908 are located one or more spring-loaded end stops 1922 which prevent the trolley 1905 from leaving the track 1908. A nose 1926 on the trolley 1905 engages with a hook 1927 on the one or more end stops 1922 in order to halt the trolley 1905. A mobile track section 1924, used to carry the trolley 1905 from one fixed track to another, or for a variety of other purposes where the trolley 1905 track is desired to be changed, has not yet engaged with the first fixed track 1908. At schematic step 2130, the mobile track section 1924 has moved closer to engagement with the first fixed track 1908, but is not yet fully engaged. One or more pins 1932 on the mobile track section 1924 engage with the end stop 1922 such that rotation of the end stop 1922 is not possible until engagement is complete.

At schematic step 1940, the mobile track section 1924 is fully engaged with the first fixed track 1908. The one or more pins 1932 on the mobile track section 1924 are now aligned such that rotation of at least a portion of the end stop 1922 is permitted via the pin slot 1942. At schematic step 1950, the trolley 1905 may move from the first fixed track 1908 to the mobile track section 1922 due to the rotation of at least a portion of the end stop 1922. At schematic step 1960, the trolley 1905 has passed from the first fixed track 1908 to the mobile track section 1922 and the end stop 1922 may only rotate to a position where the first fixed track 1908 and the mobile track section 1924 can disengage when the trolley 1905 is not present. At schematic step 2170, the mobile track section 1924 moves away, carrying the trolley 1905 with it. The trolley 1905 is secured from falling out of the mobile track by spring-loaded end-stops (1972, 1973) at both ends of the mobile track.

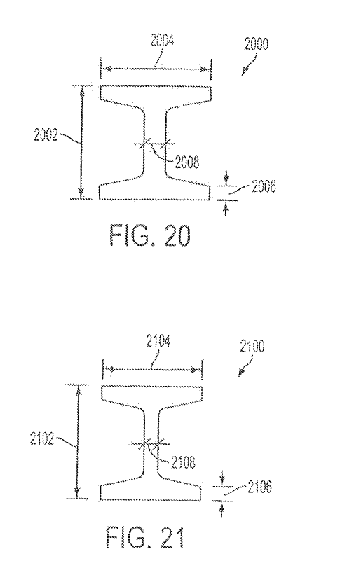

FIGS. 20 and 21 shows dimension information for I-beam structural supports that may be used in a harnessed course or unharnessed course of an amusement attraction. The harnessed or unharnessed course of the amusement attraction may include features that are the same as or similar to those previously discussed. For example, an I-beam structural support 2000 may have dimension information such that a total length 2002 is substantially equal to 3 meters, total width 2004 is substantially equal to 2.509 meters, I-height 2006 is substantially equal to 0.260 meters, and I-width 2008 is substantially equal to 0.344 meters. In another example, an I-beam structural support 2100 may have dimension information such that a total length 2102 is substantially equal to 3 meters, total width 2104 is substantially equal to 2.330 meters, I-height 2106 is substantially equal to 0.260 meters, and I-width 2108 is substantially equal to 0.170 meters. Alternative embodiments may use I-beam or other structural supports utilizing the same or different dimension information.

FIG. 22 shows a plurality of harnessed activities 2200 that may be performed between sections of track in a harnessed course of an amusement attraction. The harnessed course and/or harnessed activities may include features that are the same as or similar to those previously discussed. For example, vertical climbing 2210 may be permitted from a lower climbing platform 2214 to a higher climbing platform 2216 wherein a safety line is connected with a user and an internal track 2218 extends along a vertical portion of the climbing area. In another example, sliding may be permitted on a zip-line 2320 from a first zip-line platform 2205 to a second zip-line platform 2208 via a safety mechanism 2206 that makes sliding contact with a zip-line track 2207. In still another example, vertical dropping 2230 may be permitted from an upper drop platform 2232 to a lower drop platform 2234. The above activities may be performed by a user on the amusement attraction without having to hook or unhook from a safety system.

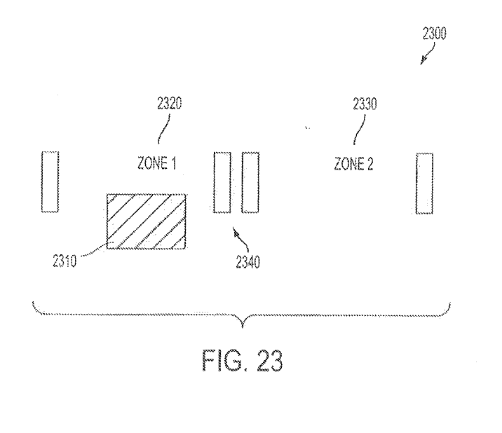

FIGS. 23-25 illustrate handshaking operation between a trolley and one or more track or track elements. In FIG. 23, a handshaking system 2300 is shown for a trolley 2310 or other safety mechanism. The handshaking operation, trolley 2310 (e.g., safety or belay mechanism), track, and/or track elements may include features that are the same as or similar to those previously discussed. A first zone 2320 (e.g., having a track for movement of the trolley 2310) is separated from a second zone 2330 (e.g., having a track for movement of the trolley 2310) via one or more gates 2340.

In one embodiment, the gates may be physical structures that block movement of the trolley 2310 and/or a user of the trolley 2310 from transitioning between the first zone 2320 and the second zone 2330. In order to increase safety for users during transition, the handshaking system 2300 only allows the one or more gates 2340 to open when they are within a predetermined vicinity to the user and/or the trolley 2310. In addition, the one or more gates 2340 are not permitted to disengage from one another (e.g., if a track in the first zone 2320 and/or the second zone 2330 is a moveable track that moves closer to the first zone 2320 and/or the second zone 2330 to facilitate transfer of the trolley 2310 between the first zone 2320 and the second zone 2330. Lastly, the one or more gates 2340 may be prohibited from closing or otherwise blocking the trolley 2310 if the trolley 2310 is currently transitioning between the first zone 2320 and the second zone 2330.

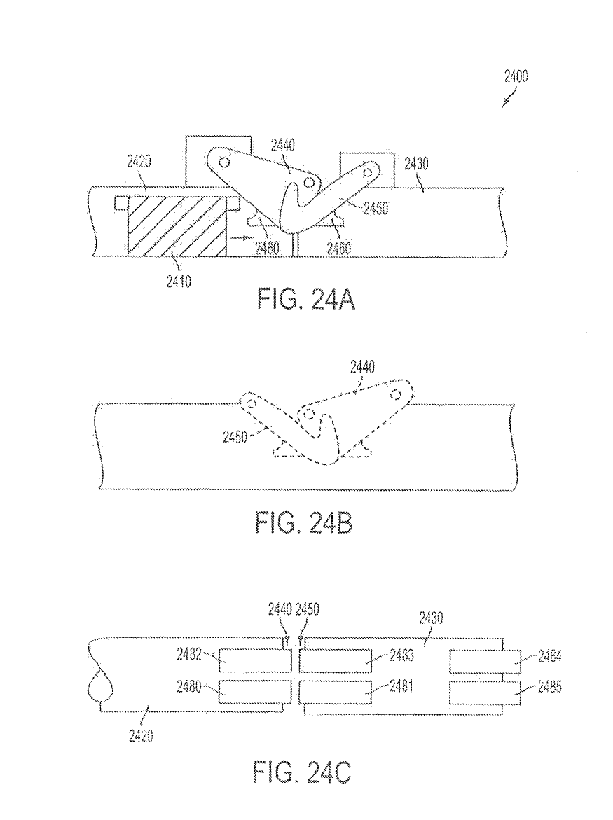

FIGS. 24A-24C show mechanical operation 2400 of one example of a handshaking system. FIG. 24A shows a front view of the mechanical operation 2400 of the handshaking system, FIG. 24B shows a rear view of the mechanical operation 2400 of the handshaking system, and FIG. 24C shows a top view of the mechanical operation 2400 of the handshaking system. The handshaking operation, trolley (e.g., safety or belay mechanism), track, and/or track elements discussed below may include features that are the same as or similar to those previously discussed. As shown, a trolley 2410 may be configured to move from a first track 2420 to a second track 2430. A first latching component 2440 (e.g., a hook or a loop) coupled with the first track 2420 is configured to engage with a second latching component 2450 (e.g., a corresponding hook or a loop) coupled with the second track 2430. Thus, the first track 2420 and the second track 2430 may be brought within a predetermined and stable distance of one another such that the trolley 2410 can transfer from the first track 2420 to the second track 2430 or vice versa.

The first latching component 2440 and/or the second latching component 2450 may also include one or more teeth 2460, or receptacles in an alternative embodiment, that are configured to engage with a portion of the trolley 2410 for aiding in the movement of the trolley 2410 from one track to another. In one embodiment, the first and/or second latching components (2440, 2450) may be safety systems that are moveable upon the first and/or second tracks (2420, 2430), such that the trolley links with the safety systems that operate or perform other activities of the amusement attraction (e.g., vertical drops, ziplines, etc.). The first latching component 2440 may be comprised of a first hook component 2482 and a first loop component 2480 that are configured to engage or mate with the second latching component 2450, which may be a second loop component 2483 and a second hook component 2484. An alternative embodiment, may utilize different numbers of latching components or latching components with different mechanical operation so long as they are configured to engage with one another. In one example, as shown in FIG. 24C, certain tracks may have latching components at each end of a track segment in certain embodiments.

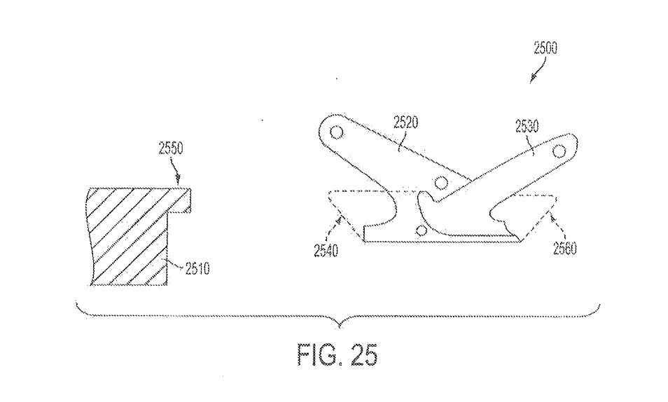

FIG. 25 shows the mechanical operation 2500 of one example of a latching system for movement of a trolley 2510 between a plurality of tracks. The latching system, trolley (e.g., safety or belay mechanism), track, and/or track elements may include features that are the same as or similar to those previously discussed. As shown, the trolley 2510 may be configured to switch from a first track that is coupled with a first latching element 2520 (e.g., a loop latching component) to a second track that is coupled with a second latching element 2530 (e.g., a hook latching component). The first latching element 2520 and the second latching element 2530 are configured to removeably engage with one another when within a predetermined distance of each other. The second latching element 2530 includes a nose 2540 that is configured to engage with a nub 2550 or other protrusion of the trolley 2510. Thus, after engagement of the nose 2540 with the nub 2550 and transition of the trolley 2510 from the first track to the second track, the first and second tracks, and their corresponding latching elements, may disconnect from one another. The first latching element 2520 may also include a nose 2560 for connecting with a nub of the trolley 2510 in order to facilitate movement of the trolley 2510 from the second track to the first track. In an alternative embodiment, any of a variety of connecting means for the tracks and/or latching elements may be used.

Any of a variety of amusement attractions may be designed that use any or all of the above described concepts. For example, the safety or belay system may attach at any of a variety of locations to a user (e.g., at their waist in front, at their waist in the rear, may be rotatable around their waist utilizing a belt that allows for movement, such as through ball bearings, etc.). In addition, a tracking system (e.g., through the use of biometrics or Radio Frequency Identification (RFID) tags) may be used to provide additional sources of entertainment for users. For example, participants may achieve points or stamps or other rewards based upon their successful completion of various game activities that are tracked by the tracking system of the amusement attraction.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. A safety system for coupling a user to an amusement attraction comprising:
a safety mechanism having:
a chassis;
an aperture in the chassis, the aperture configured to accommodate a portion of a track;
at least two wheels proximate the aperture, the at least two wheels configured to contact the track when the track is positioned in the aperture;
a handshake mechanism configured to secure a second safety mechanism.

2. The safety system of claim 1, further comprising the second safety mechanism.

3. The safety system of claim 2, wherein the second safety mechanism having:
a body defining a planar surface;
an extension from the planar surface.

4. The safety system of claim 3, wherein the handshake mechanism comprises rails to support and contact the planar surface of the second safety mechanism.

5. The safety system of claim 4, wherein the rails are positioned to define a space between the rails to fit the extension of the second safety mechanism.

6. The safety system of claim 5, wherein the handshake mechanism comprises a securing mechanism to obstruct the space between the rails and prevent passage of the extension past the securing mechanism.

7. The safety system of claim 6, wherein the securing mechanism comprises a spring loaded latch.

8. The safety system of claim 1, further comprising the track.

9. The safety system of claim 8, wherein the track is configured with a downward slope configured to permit a user to traverse the track using gravity and handing from the safety mechanism.

10. The safety system of claim 9, wherein the track is configured with an upward sloped braking section configured to dissipate the kinetic energy of the safety mechanism traveling along the track.

11. The safety system of claim 10, wherein the track includes a one way mechanism for preventing motion of the safety mechanism along the track in a direction opposite a direction of entry.

12. The safety system of claim 11, further comprising a conveyor configured to couple to the safety mechanism and move the safety mechanism toward the end of the track.

14. The safety system of claim 11, wherein the conveyer comprises a chain conveyor and the safety mechanism includes a projection configured to mate with the chain conveyor.

15. The safety system of claim 1, wherein the aperture comprises an opening to an exterior of the chassis on a top side of the chassis.

16. The safety system of claim 15, further comprises the track, the track comprises a first support portion exterior of the chassis and a rail portion configured to fit within the aperture, and a connector between the support portion and the rail portion configured to fit within the opening.

17. The safety system of claim 1, wherein the safety mechanism further comprises a speed controller.

18. The safety system of claim 17, wherein the speed controller comprises a centrifugal clutch coupled through an axle to each of the at least two wheels.
